(19) United States
(12) Patent Application Publication
(10) Pub. No.: US 2022/0397922 A1
(43) Pub. Date: Dec. 15, 2022

(54) HEATING CONTROL SYSTEM AND WINDSHIELD

(71) Applicant: AGC Inc., Tokyo (JP)

(72) Inventors: Tetsuji IRIE, Tokyo (JP); Shunsuke SADAKANE, Tokyo (JP); Takayuki KIMURA, Tokyo (JP)

(73) Assignee: AGC Inc., Tokyo (JP)

(21) Appl. No.: 17/892,983

(22) Filed: Aug. 22, 2022

Related U.S. Application Data
(63) Continuation of application No. PCT/JP2020/048572, filed on Dec. 24, 2020.

(30) Foreign Application Priority Data
Mar. 2, 2020 (JP) 2020-034766
Mar. 2, 2020 (JP) 2020034766

(51) Int. Cl. G05D 23/19; H05B 3/84; B60J 1/02

(52) U.S. Cl. CPC G05D 23/1932; H05B 3/84; B60J 1/02; H05B 2203/005

(57) ABSTRACT

A heating control system for controlling a heating element provided on glass including a sensor information acquisition unit configured to acquire sensor information from one or more sensors, and a control processing unit configured to control a first heating element provided in a first region of the glass and a second heating element provided in a second region of the glass based on the sensor information. The control processing unit comprises a temperature difference reduction processing unit configured to execute temperature difference reduction processing for controlling at least one of the first heating element and the second heating element so that a temperature difference between a glass temperature of a third region positioned between a first region and a second region of the glass and a glass temperature of the first region or a glass temperature of the second region does not exceed an upper limit value.

### INCORPORATION BY REFERENCE

This application is a continuation of PCT Application No. PCT/JP2020/048572, filed on Dec. 24, 2020, which is based upon and claims the benefit of priority from Japanese Patent Application 2020-034766 filed on Mar. 2, 2020, the disclosure of which is incorporated herein in its entirety by reference.

### BACKGROUND

The present disclosure relates to a heating control system for a windshield and a windshield.

A windshield in which a heating element is disposed in each of two separate regions of glass is known (Japanese Unexamined Patent Application Publication No. 2017-216193).

### SUMMARY

However, in the above-described related art, there is a possibility that a region (referred to as an “intermediate region” in this paragraph) may be generated between the two regions in each of which heating elements are disposed, respectively, and that differences between a glass temperature of the intermediate region and those of the two regions becomes large. If the differences between the glass temperature of the intermediate region and the glass temperatures of the regions in which the heating elements are disposed become too large, a defect in the glass may occur in the intermediate region due to the difference between the glass temperature of the intermediate region and those of the regions in which the heating elements are disposed.

Thus, in one aspect, an object of the present disclosure is to reduce the possibility of a defect in glass occurring in a region between regions where heating elements are disposed, respectively.

In one aspect, a heating control system for controlling a heating element provided on glass that separates inside of a vehicle from outside thereof. The heating control system comprises:

a sensor information acquisition unit configured to acquire sensor information from one or more sensors; and

a control processing unit configured to control a first heating element provided in a first region of the glass and a second heating element provided in a second region different from the first region of the glass based on the sensor information.

The control processing unit comprises a temperature difference reduction processing unit configured to execute temperature difference reduction processing for controlling at least one of the first heating element and the second heating element so that a temperature difference between a glass temperature of a third region positioned between a first region and a second region of the glass and a glass temperature of the first region or a glass temperature of the second region does not exceed an upper limit value.

In one aspect, according to the present disclosure, it is possible to reduce the possibility of defects in glass occurring in a region between regions where heating elements are disposed, respectively.

### BRIEF DESCRIPTION OF DRAWINGS

FIG. 1 is an overview diagram of a vehicle windshield according to a first embodiment;

FIG. 2 is an enlarged diagram of a Q1 part of FIG. 1;

FIG. 3 is a schematic cross-sectional diagram taken along the line A-A of FIG. 2;

FIG. 4 is an overview diagram of a control system for the vehicle windshield;

FIG. 5 is a functional diagram showing a function of a control device related to windshield heating control;

FIG. 6 is an explanatory diagram of threshold information;

FIG. 7 is an explanatory diagram of a cause of a defect (e.g., a crack) that may occur in a third region;

FIG. 8A is an explanatory diagram (part 1) for a case where temperature difference reduction processing is executed in a situation where only second energization processing is being executed;

FIG. 8B is an explanatory diagram (part 2) for a case where the temperature difference reduction processing is executed in a situation where only the second energization processing is being executed;

FIG. 8C is an explanatory diagram (part 3) for a case where the temperature difference reduction processing is executed in a situation where only the second energization processing is being executed;

FIG. 8D is an explanatory diagram (part 4) for a case where the temperature difference reduction processing is executed in a situation where only the second energization processing is being executed;

FIG. 9A is an explanatory diagram (part 1) for a case where temperature difference reduction processing is executed in a situation where first energization processing and second energization processing are executed;

FIG. 9B is an explanatory diagram (part 2) for a case where the temperature difference reduction processing is executed in a situation where the first energization processing and the second energization processing are executed;

FIG. 9C is an explanatory diagram (part 3) for a case where the temperature difference reduction processing is executed in a situation where the first energization processing and the second energization processing are executed;

FIG. 9D is an explanatory diagram (part 4) for a case where the temperature difference reduction processing is executed in a situation where the first energization processing and the second energization processing are executed;

FIG. 10A is an explanatory diagram for a case (part 1) in which the temperature difference reduction processing is executed in a situation where only the second energization processing is being executed when a distance between a first region and a second region is relatively large;

FIG. 10B is an explanatory diagram for a case (part 2) in which the temperature difference reduction processing is executed in a situation where only the second energization processing is being executed when a distance between the first region and the second region is relatively large;

FIG. 10C is an explanatory diagram for a case (part 3) in which the temperature difference reduction processing is executed in a situation where only the second energization processing is being executed when a distance between the first region and the second region is relatively large;

FIG. 10D is an explanatory diagram for a case (part 4) in which the temperature difference reduction processing is executed in a situation where only the second energization processing is being executed when a distance between the first region and the second region is relatively large;

FIG. 11 is an overview flowchart showing an example of processing executed by the control device according to this embodiment in connection with windshield heating control;

FIG. 12 is an overview flowchart showing an example of first heating element control processing (Step S2 of FIG. 11);

FIG. 13 is an overview flowchart showing an example of second heating element control processing (Step S3 of FIG. 11); and FIG. 14 is an enlarged diagram of a part of a vehicle windshield 1A according to a second embodiment.

### DESCRIPTION OF EMBODIMENTS

Hereinafter, each embodiment will be described in detail with reference to the attached drawings. Note that, in the attached drawings, for ease of viewing, there are cases in which only some of a plurality of parts having the same attribute are denoted by reference signs. When the direction is not specifically described in the drawing for explaining the embodiments, the direction in the drawing is referred to, and the direction of each drawing corresponds to the direction of symbols and numbers. Further, deviations in the direction such as parallel, right angle, and vertical may be allowed to a degree that does not impair the effect.

Hereinafter, various embodiments of a vehicle windshield 1 attached to the front of a vehicle will be described by way of example. However, the vehicle windshield 1 described below may be attached to the side or rear of the vehicle.

### First Embodiment

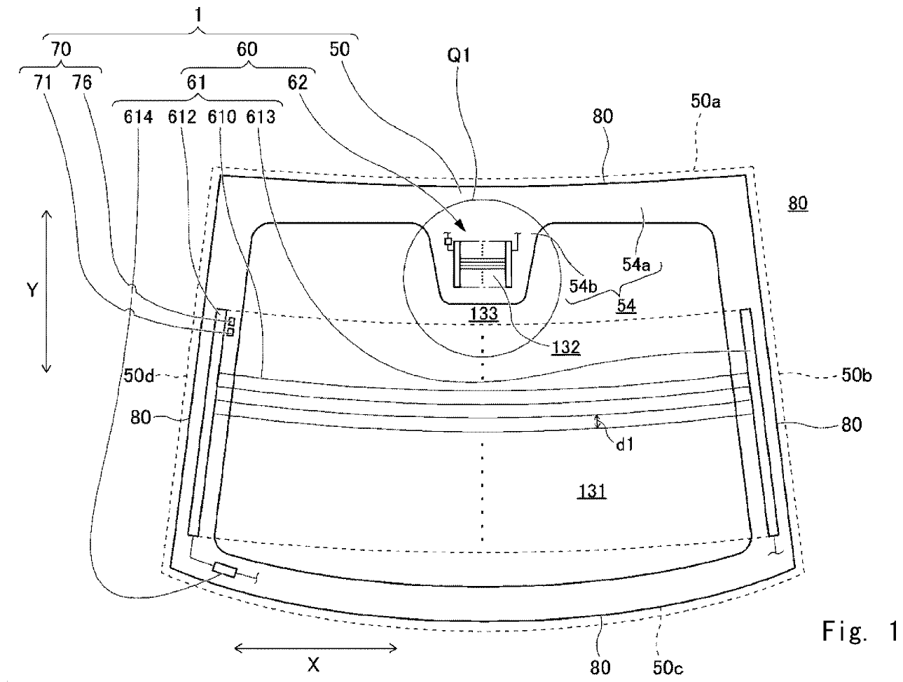

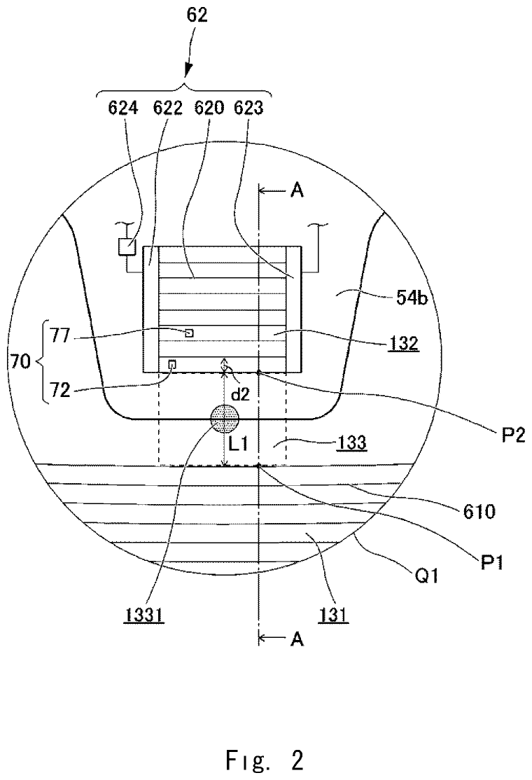

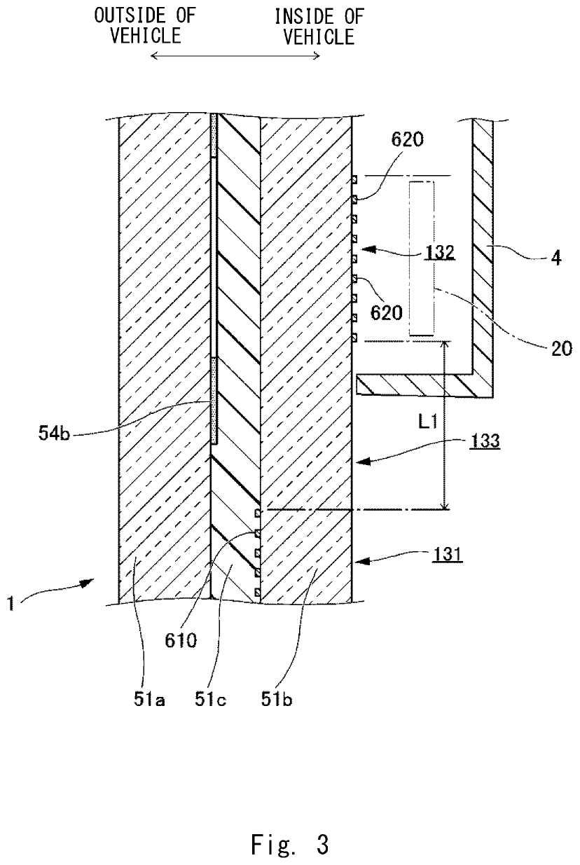

FIG. 1 is an overview diagram of the vehicle windshield 1 according to a first embodiment. FIG. 2 is an enlarged diagram of a Q1 part of FIG. 1. FIG. 3 is a schematic cross-sectional diagram taken along the line A-A of FIG. 2. FIG. 3 shows an overview of a cover 4 not shown in FIG. 1 and FIG. 2. FIG. 3 shows outside and inside (passenger compartment side) of a vehicle with a center of a window glass 50 in the thickness direction as a reference.

FIG. 1 also shows a vehicle housing 80 to which the vehicle windshield 1 is attached. FIG. 1 is a view when a surface of the window glass (windshield) 50 is viewed from the opposite side, and is a view when the window glass 50 is viewed from the passenger compartment of the vehicle. Note that the window glass 50 can be applied not only to vehicles but also to various mobile bodies, and can be applied to trains, buses, ships, aircraft, construction machines, and the like.

Hereinafter, each region (a first region 131, etc.) of the window glass 50 is a region on the surface of the window glass 50 (for example, the surface on the passenger compartment side), and instead may be a region including a thick part of the window glass 50. A distance between the regions of the window glass 50 (or a distance of the same kind) is the shortest distance along the surface of the window glass 50, and instead may be the shortest distance on an approximate plane when a radius of curvature of the window glass 50 is relatively large. Here, it is assumed that an X direction and a Y direction which are two directions orthogonal to each other are defined as shown in FIG. 1, and an XY plane is a plane which can approximate the surface of the window glass 50. The X direction corresponds to a vehicle width direction, and the Y direction corresponds to an up-down direction (the vertical direction may be vertically inclined in the up-down direction).

The vehicle windshield 1 includes a window glass 50, a heating device 60, and a sensor device 70, as shown very roughly in FIG. 1. In FIG. 1, a part of the sensor device 70 (see FIG. 2) is not shown.

The window glass 50 is a window plate covering an opening of the vehicle housing 80. Although the substrate of the window glass 50 is not limited to glass, and may be resin, film, or the like, it should be a base material that passes radio waves. The window glass 50 may be formed by laminating a plurality of substrates, and may be provided with a film or the like for implementing various functions, or may be formed with an antenna or the like. In this embodiment, as an example, the window glass 50 may be produced by superimposing two sheets of glass 51a and 51b with an intermediate film 51c interposed therebetween (see FIG. 3) to produce a polymer, and pressurizing and heating the produced polymer in an autoclave or the like.

The window glass 50 is attached to a body flange formed on the vehicle housing 80. Outer peripheral edges 50a, 50b, 50c, and 50d of the window glass 50 are shown by broken lines in FIG. 1. The vehicle housing 80 has an edge part 80 of the body flange forming a window opening part of a vehicle body.

The window glass 50 for a windshield has a shielding region in a peripheral region on a surface. The shielding region is a region where, for example, a black or brown shielding film 54 is formed or a region where a part of the intermediate film is colored. The shielding film 54 is formed of a ceramic such as a black ceramic film or a black organic ink film. Note that the shielding film 54 improves the design property of the vehicle exterior and passenger compartment when an on-vehicle device is mounted, and transmits radio waves. The shielding film 54 has a constant width part 54a formed with a substantially constant width from an outer peripheral edge of the window glass 50, and a projection 54b projecting downward at an upper part and a central part (the center part in the left-right direction) of the window glass 50. Note that the projection 54b may have a shape in which the width in the left-right direction becomes smaller toward the lower side (a symmetrical and substantially trapezoidal shape), or may have a shape in which the width in the left-right direction becomes larger. The projection 54b may have a cut in a part.

The heating device 60 is for heating the window glass 50. The heating device 60 includes a first heating device 61 and a second heating device 62.

The first heating device 61 is provided in association with the first region 131 of the window glass 50.

The first region 131 is a part of the entire region of the window glass 50, and is set in consideration of the forward visibility of an occupant such as a driver. The shielding film 54 described above is provided so as not to affect the forward visibility through the first region 131. The first region 131 may have any shape, and may be rectangular in a plan view (as seen from a vertical point of view with respect to the XY plane; the same applies to the following descriptions) as shown in FIG. 1. In a modified example, the shape of the first region 131 may include a shape having a recess or a projection in an outer peripheral part in a plan view.

The first heating device 61 includes first heating elements 610, bus bars 612 and 613, and a switch unit 614.

Each of the first heating elements 610 is in a form of a heat transfer line or a heat transfer film and has a characteristic of generating heat when an electric current flows therethrough. The first heating elements 610 may be provided on an outside surface of the glass 51b of the window glass 50, which is on the passenger compartment side, for example, as shown in FIG. 3. The first heating elements 610 are disposed within the first region 131. In other words, the first heating elements 610 are disposed in a mode defining the first region 131. Here, a boundary of the first region 131 in the Y direction is defined by the first heating elements 610. That is, an upper boundary of the first region 131 in the Y direction is the uppermost position of the first heating elements 610 in the Y direction, and a lower boundary of the first region 131 in the Y direction is the lowermost position of the first heating elements 610 in the Y direction. A boundary of the first region 131 in the X direction is defined by a line connecting end positions (positions where the first heating elements 610 are connected to the bus bars 612 and 613) of the respective first heating elements 610 on each side in the X direction.

The first heating elements 610 are preferably positioned so that uniform heating is achieved within the first region 131 and there is substantially no uneven distribution in the arrangement of the first heating elements 610. Note that in this embodiment, as an example, a plurality of heat transfer lines serving as the first heating elements 610 are extended in the X direction in such a mode that there is a constant pitch dl therebetween in the Y direction, as shown by FIG. 1. Note that the first heating elements 610 are not continuous with each other, and instead may be formed in such a mode that they are folded back from one end of the first region 131 in the X direction to the other end thereof and folded back from the other end to the one end (in a reciprocating mode).

In this embodiment, as an example, the first heating elements 610 are extended in the X direction and are arranged in a row in the Y direction, but the present disclosure is not limited thereto. For example, the heat transfer lines constituting the first heating elements 610 may be extended in the Y direction and aligned in the X direction.

Copper, silver, or tungsten is used as the heat transfer line. As the heating film, a dielectric layer/silver/dielectric layer or a dielectric layer/silver/dielectric layer/silver/dielectric layer is used. As the dielectric layer, tin oxide, zinc oxide, silicon nitride, titanium oxide, or aluminum oxide is used.

The bus bar 612 forms, for example, an electrode on a positive electrode side and is electrically connected to the positive electrode side of an on-vehicle battery (not shown). The bus bar 612 may be in a form of, for example, a film of a conductive material. This also applies to other bus bars such as the bus bar 613. The on-vehicle battery may be electrically connected to the bus bar 612 via a power generation unit (not shown) that generates a predetermined power supply voltage. For example, as shown in FIG. 1, the bus bar 612 is extended in the Y direction on the left side in the X direction of the first region 131 in a mode that the bus bar 612 is positioned within the constant width part 54a on the left side in the X direction in a plan view.

The bus bar 613 forms, for example, an electrode on a negative electrode side and is electrically connected to the negative electrode side (ground) of the on-vehicle battery (not shown). For example, as shown in FIG. 1, the bus bar 613 is extended in the Y direction on the right side in the X direction of the first region 131 in a mode that the bus bar 613 is positioned within the constant width part 54a on the right side in the X direction in a plan view. The bus bar 613 may be symmetrical to the bus bar 612 on the left and right sides.

The switch unit 614 is electrically connected between the bus bar 612 and the on-vehicle battery. The switch unit 614 includes a switch for turning on or off the energization of the first heating elements 610. Note that this type of switch may be in a form of, for example, a relay or a semiconductor switch. When the switch unit 614 is controlled to be on, conduction between the first heating elements 610 and the on-vehicle battery (i.e., energization to the first heating elements 610) is achieved, and the window glass 50 in the first region 131 is heated by the heat generated by the first heating elements 610.

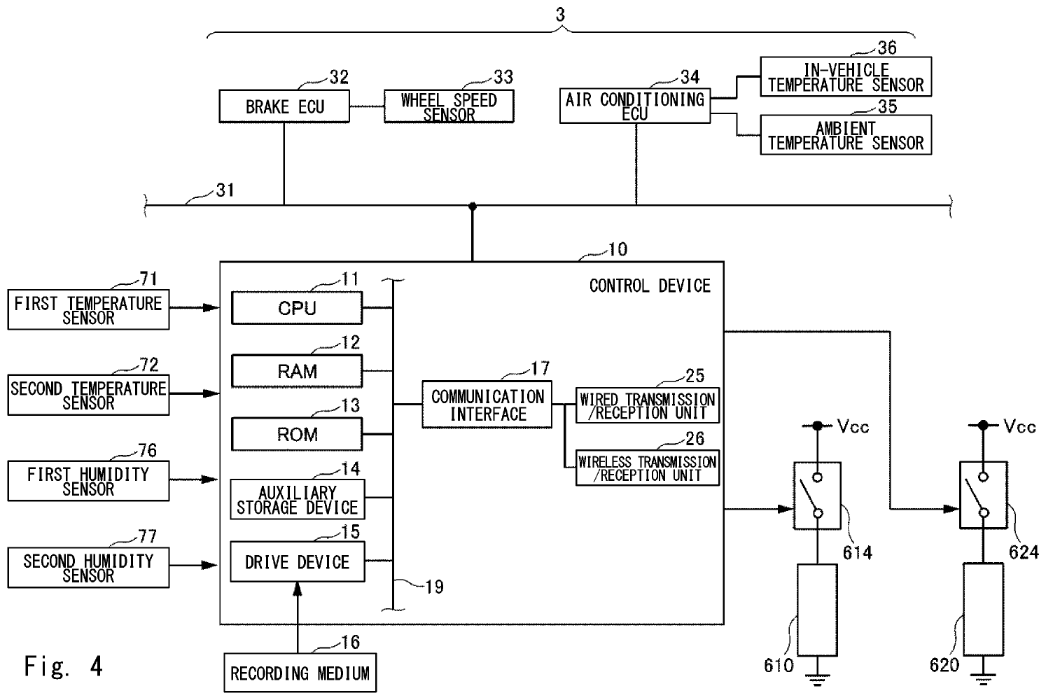

The on or off state of the switch unit 614 is controlled by a control device 10 (see FIG. 4). Although the wiring from the switch unit 614 to the control device 10 is not shown in FIG. 1 and so on, the wiring may be formed in a region that overlaps the constant width part 54a in a plan view in a manner similar to the various wiring related to the first heating device 61.

The second heating device 62 is provided in association with the second region 132 of the window glass 50.

The second region 132 is a part of the entire region of the window glass 50, and is set in association with a vehicle periphery monitoring sensor 20 (see the rectangle of the chain line of FIG. 3). The vehicle periphery monitoring sensor 20 may be a radar sensor (e.g., a millimeter wave radar sensor), an image sensor (i.e., a camera, for example, a stereo camera), or the like. As roughly shown in FIG. 3, the second region 132 is covered with the cover 4 on the passenger compartment side. The cover 4 may have any shape as long as it covers at least a part of the second region 132, and may have, for example, a shape of a housing. In this case, for example, a radar sensor, an image sensor, LiDAR, a substrate, or the like may be disposed in a space formed between the second region 132 of the window glass 50 and the cover 4.

As described above, the second area 132 is set in association with the forward visibility with respect to an “eye” of the vehicle peripheral monitoring sensor 20. Therefore, the above-described projection 54b of the shielding film 54 may have an opening so as not to affect the forward visibility through the second region 132. However, if the shielding film 54 transmitting radio waves does not affect the “eye” of the vehicle peripheral monitoring sensor 20, the shielding film 54 may be formed to overlap the second region 132 in a plan view.

The second region 132 may be any shape, and may be rectangular in a plan view, as shown in FIG. 2. However, in the modified example, the shape of the second region 132 may include a shape having a recess or a projection in the outer periphery in a plan view.

The second heating device 62 includes second heating elements 620, bus bars 622 and 623, and a switch unit 624.

Each of the second heating elements 620 is in a form of a heat transfer line or a heating film and has a characteristic of generating heat when an electric current flows therethrough. The second heating elements 620 may be provided on a passenger compartment side surface of the glass 51b of the window glass 50, which is on the passenger compartment side, for example, as shown in FIG. 3. The second heating elements 620 are disposed within the second region 132. In other words, the second heating elements 620 are disposed in a mode defining the second region 132. Here, a boundary of the second region 132 in the Y direction is defined by the second heating elements 620. That is, an upper boundary of the second region 132 in the Y direction is the uppermost position of the second heating elements 620 in the Y direction, and a lower boundary of the second region 132 in the Y direction is the lowermost position of the second heating elements 620 in the Y direction. A boundary of the second region 132 in the X direction is defined by a line connecting end positions (positions where the second heating elements 620 are connected to the bus bars 622 and 623) of the respective second heating elements 620 on each side in the X direction.

The second heating elements 620 are preferably positioned so that uniform heating is achieved within the second region 132 and there is substantially no uneven distribution in the arrangement of the second heating elements 620. Note that in this embodiment, as an example, a plurality of heat transfer lines serving as the second heating elements 620 are extended in the X direction in such a mode that they are arranged with a constant pitch d2 therebetween in the Y direction, as shown in FIG. 2. The pitch d2 may be the same as or different from the pitch d1. When the cover 4 (see FIG. 3) covering the second region 132 from the passenger compartment side is provided as in this embodiment, the humidity in the second region 132 tends to increase. Thus, the pitch d2 may be smaller than the pitch d1 in order to easily prevent dew condensation in the second region 132.

The second heating elements 620 preferably have a higher heat generation density (W/m²) than that of the first heating elements 610. In this case, the glass temperature of the second region 132 can be raised relatively quickly. When the cover 4 (see FIG. 3) covering the second region 132 from the passenger compartment side is provided as in this embodiment, the humidity in the second region 132 tends to increase. Therefore, by increasing the heat generation density of the second heating elements 620, dew condensation in the second region 132 can be effectively suppressed.

The heat generation density of the second heating elements 620 is preferably within the range of 1.5 to 6 times the heat generation density of the first heating elements 610, more preferably within the range of 1.8 to 5 times the heat generation density of the first heating elements 610, and most preferably within the range of 2 to 3 times the heat generation density of the first heating elements 610. For example, the heat generation density of the first heating elements 610 may be about 400 W/m², and in this case, the heat generation density of the second heating elements 620 may be within the range of, for example, 900 W/m² to 2200 W/m².

Note that in this embodiment, as an example, the second heating elements 620 are not continuous with each other, and instead may be formed in such a mode that they are folded back from one end of the second region 132 in the X direction to the other end thereof and folded back from the other end to the one end (in a reciprocating mode). In this embodiment, as an example, the second heating elements 620 are extended in the X direction and are arranged in a row in the Y direction, but the present disclosure is not limited thereto. For example, the heat transfer lines constituting the second heating elements 620 may be extended in the Y direction and aligned in the X direction.

The bus bar 622 forms, for example, an electrode on a positive electrode side and is electrically connected to the positive electrode side of the on-vehicle battery (not shown). The on-vehicle battery may be electrically connected to the bus bar 622 via a power generation unit (not shown) that generates a predetermined power supply voltage. For example, as shown in FIG. 2, the bus bar 622 is extended in the Y direction to the left side in the X direction of the second region 132.

The bus bar 623 forms an electrode on the negative electrode side, for example, and is electrically connected to the negative electrode side (ground) of the on-vehicle battery (not shown). The bus bar 623 is extended in the Y direction to the right side in the X direction of the second region 132 as shown in FIG. 2, for example. The bus bar 623 may be symmetrical to the bus bar 622 on the left and right sides.

The switch unit 624 is electrically connected between the bus bar 622 and the on-vehicle battery. The switch unit 624 includes a switch for turning on or off the energization of the second heating elements 620. Note that this type of switch may be in a form of, for example, a relay or a semiconductor switch. When the switch unit 624 is controlled to be on, conduction between the second heating elements 620 and the on-vehicle battery (i.e., energization to the second heating elements 620) is achieved, and the window glass 50 in the second region 132 is heated by the heat generated by the second heating elements 620.

The on or off state of the switch unit 624 is controlled by the control device 10 (see FIG. 4). Although the wiring from the switch unit 624 to the control device 10 is not shown in FIG. 1 and so on, the wiring may be formed in a region that overlaps the constant width part 54a and the projection 54b in a plan view in a manner similar to the various wiring related to the second heating device 62. The wiring may be formed by using a substrate that may be disposed between the second region 132 of the window glass 50 and the cover 4, without using a region that overlaps the constant width part 54a in a plan view.

In this embodiment, the first heating elements 610 of the first heating device 61 and the second heating elements 620 of the second heating device 62 are electrically connected to the on-vehicle battery (not shown) in a parallel relationship to each other. The switch unit 614 of the first heating device 61 is not positioned on the wiring between the second heating elements 620 and the on-vehicle battery (not shown), and the switch unit 624 of the second heating device 62 is not positioned on the wiring between the first heating elements 610 and the on-vehicle battery (not shown). Therefore, basically, the first heating elements 610 and the second heating elements 620 can operate independently of each other.

The sensor device 70 includes a first temperature sensor 71, a second temperature sensor 72, a first humidity sensor 76, and a second humidity sensor 77.

The first temperature sensor 71 is in a form of a thermistor or the like, and is provided in association with the first region 131. The first temperature sensor 71 is provided to detect the glass temperature of the first region 131. For this purpose, the first temperature sensor 71 is preferably provided within the first region 131 or in the vicinity of the first region 131. In FIG. 1, for example, the first temperature sensor 71 is provided on the left side of the first region 131 in the X direction and also on the upper side thereof in the Y direction in a mode that the first temperature sensor 71 is positioned within the constant width part 54a on the left side in the X direction in a plan view. The first temperature sensor 71 is preferably disposed in such a way that a sensing element is in contact with the glass surface.

The first temperature sensor 71 supplies an electrical signal (an example of temperature information) indicating the glass temperature of the first region 131 to the control device 10 (see FIG. 4). Although the wiring from the first temperature sensor 71 to the control device 10 is not shown in FIG. 1 or the like, the wiring may be formed in a region that overlaps the constant width part 54a in a plan view in a manner similar to the various wiring related to the first heating device 61.

The second temperature sensor 72 is in a form of a thermistor or the like, and is provided in association with the second region 132. The second temperature sensor 72 is provided to detect the glass temperature of the second region 132. For this purpose, the second temperature sensor 72 is preferably provided within the second region 132 or in the vicinity of the second region 132. In FIG. 2, for example, the second temperature sensor 72 is provided on the lower side within the second region 132 in the Y direction in a mode that the second temperature sensor 72 is positioned within the projection 54b in a plan view.

The second temperature sensor 72 supplies an electrical signal (an example of temperature information) indicating the glass temperature of the second region 132 to the control device 10 (see FIG. 4). Although the wiring from the second temperature sensor 72 to the control device 10 is not shown in FIG. 1 or the like, the wiring may be formed in a manner similar to the various wiring related to the second heating device 62.

The first humidity sensor 76 is provided in association with the first region 131. The first humidity sensor 76 is provided to detect the humidity of the air in the first region 131. For this purpose, the first humidity sensor 76 is preferably provided within the first region 131 or in the vicinity of the first region 131. In FIG. 1, as an example, the first humidity sensor 76 is provided on the left side of the first region 131 in the X direction and on the upper side thereof in the Y direction in a mode that the first humidity sensor 76 is positioned within the constant width part 54a on the left side in the X direction in a plan view. The first humidity sensor 76 is preferably disposed in such a way that a sensing element (such as a moisture-sensitive material) is positioned at a position separated from the glass surface by the thickness of a boundary layer.

In FIG. 1, the first humidity sensor 76 is a body separate from the first temperature sensor 71, and may instead be formed as an integrated circuit (IC) in which the first temperature sensor 71 is integrated therewith.

The first humidity sensor 76 supplies an electrical signal indicating humidity at the installed position to the control device 10 (see FIG. 4). The wiring from the first humidity sensor 76 to the control device 10 may be formed in a mode similar to that of the first temperature sensor 71.

The second humidity sensor 77 is provided in association with the second region 132. The second humidity sensor 77 is provided to detect the humidity of the air in the second region 132. For this purpose, the second humidity sensor 77 is preferably provided within the second region 132 or in the vicinity of the second region 132. In FIG. 2, as an example, the second humidity sensor 77 is provided in a mode that the second humidity sensor 77 is positioned within the second region 132 in a plan view. The second humidity sensor 77 is preferably disposed in such a way that a sensing element (such as a moisture-sensitive material) is positioned at a position separated from the glass surface by the thickness of a boundary layer.

In FIG. 2, the second humidity sensor 77 is a body separate from the second temperature sensor 72, and may instead be formed as an integrated circuit (IC) in which the second temperature sensor 72 is integrated therewith.

The second humidity sensor 77 supplies an electrical signal indicating humidity at the installed position to the control device 10 (see FIG. 4). The wiring from the second humidity sensor 77 to the control device 10 may be formed in a mode similar to that of the second temperature sensor 72.

Next, the control system for the vehicle windshield 1 will be described with reference to FIGS. 4 to 7.

FIG. 4 is an overview diagram of the control system related to the vehicle windshield 1.

The control system for the vehicle windshield 1 includes the control device 10. The control device 10 may be implemented as a body ECU (Electronic Control Unit) for controlling locking or unlocking of doors of a vehicle.

The control device 10 includes a CPU (Central Processing Unit) 11, a RAM (Random Access Memory) 12, a ROM (Read Only Memory) 13, an auxiliary storage device 14, and a drive device 15, and a communication interface 17 connected to the bus 19, and a wired transmission/reception unit 25 and a wireless transmission/reception unit 26 connected to the communication interface 17.

The auxiliary storage device 14 is, for example, an HDD (Hard Disk Drive) or SSD (Solid State Drive), and is a storage device for storing data related to application software or the like.

The wired transmission/reception unit 25 includes a transmission/reception unit capable of communication using an in-vehicle network 31 conforming to a protocol such as CAN (Controller Area Network). Various electronic components 3 are connected to the wired transmission/reception unit 25 via the in-vehicle network 31.

In this embodiment, the various electronic components 3 include a brake ECU 32, a wheel speed sensor 33, an air conditioning ECU 34, an ambient temperature sensor 35, an in-vehicle temperature sensor 36, and so on.

The brake ECU 32 controls a braking device (not shown) of the vehicle based on sensor information or the like from the wheel speed sensor 33, etc. The wheel speed sensor 33 detects a vehicle speed pulse corresponding to the wheel speed. The brake ECU 32 calculates the vehicle speed based on vehicle speed pulse information from the wheel speed sensor 33, and transmits the vehicle speed information to the in-vehicle network 31. In this case, the control device 10 connected to the in-vehicle network 31 can acquire the vehicle speed information.

The air conditioning ECU 34 controls an air conditioner of the vehicle based on the sensor information or the like from the ambient temperature sensor 35, the in-vehicle temperature sensor 36, etc. The ambient temperature sensor 35 detects the temperature (ambient temperature) of the air outside the vehicle. The in-vehicle temperature sensor 36 detects the temperature (in-vehicle temperature) of the air in the passenger compartment. The air conditioning ECU 34 transmits ambient temperature information from the ambient temperature sensor 35 and in-vehicle temperature information from the in-vehicle temperature sensor 36 to the in-vehicle network 31.

Some of the various electronic components 3 may be electrically connected to the bus 19 or may be connected to the wireless transmission/reception unit 26.

The wireless transmission/reception unit 26 is a transmission/reception unit that is capable of communication using a wireless network. The wireless network may include a wireless communication network of a cellular phone, the Internet, a VPN (Virtual Private Network), a WAN (Wide Area Network), and the like. The wireless transmission/reception unit 26 may include a Near Field Communication (NFC) unit, a Bluetooth (registered trademark) communication unit, a Wi-Fi (Wireless-Fidelity) transmission/reception unit, an infrared transmission/reception unit, and the like.

The control device 10 may be connectable to a recording medium 16. The recording medium 16 stores a predetermined program. The program stored in the recording medium 16 is installed in the auxiliary storage device 14 or the like of the control device 10 through the drive device 15. The installed predetermined program can be executed by a CPU 11 of the control device 10. For example, the recording medium 16 may be a CD (Compact Disc)-ROM, a flexible disk, a magneto-optical disk, or the like for recording information optically, electrically, or magnetically, or a semiconductor memory, such as a ROM, a flash memory, or the like for electrically recording information.

The first temperature sensor 71, the second temperature sensor 72, the first humidity sensor 76, and the second humidity sensor 77 are electrically connected to the control device 10. The switch unit 614 and the switch unit 624 are electrically connected to the control device 10. In FIG. 4, the switch unit 614 and the switch unit 624 are roughly shown together with the first heating element 610 and the second heating element 620. In FIG. 4, Vcc represents a power supply voltage supplied to the first heating element 610 and the second heating element 620.

The control device 10 executes various types of control. The various types of control include control for the vehicle windshield 1 (hereinafter also referred to as “windshield heating control”). The windshield heating control includes controlling the first heating device 61 and the second heating device 62 based on various sensor information from the first temperature sensor 71, the second temperature sensor 72, the first humidity sensor 76, and the second humidity sensor 77.

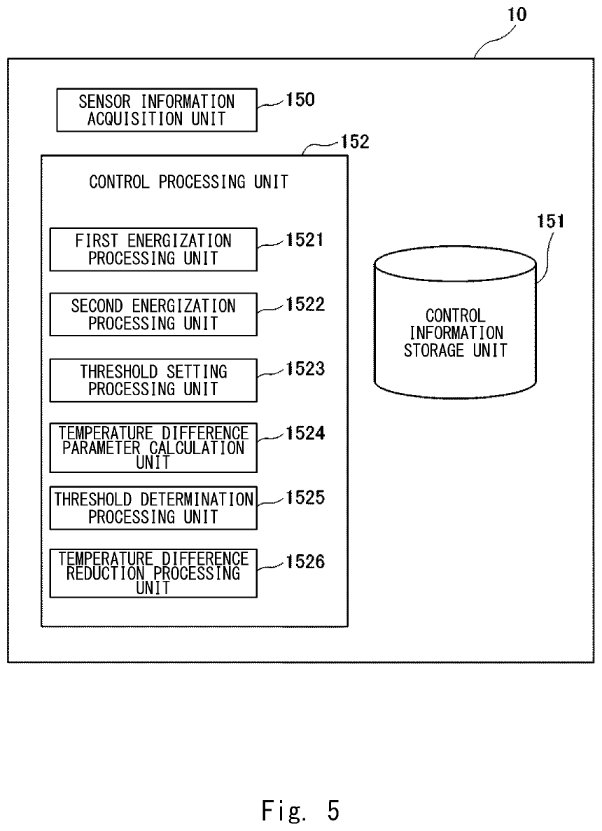

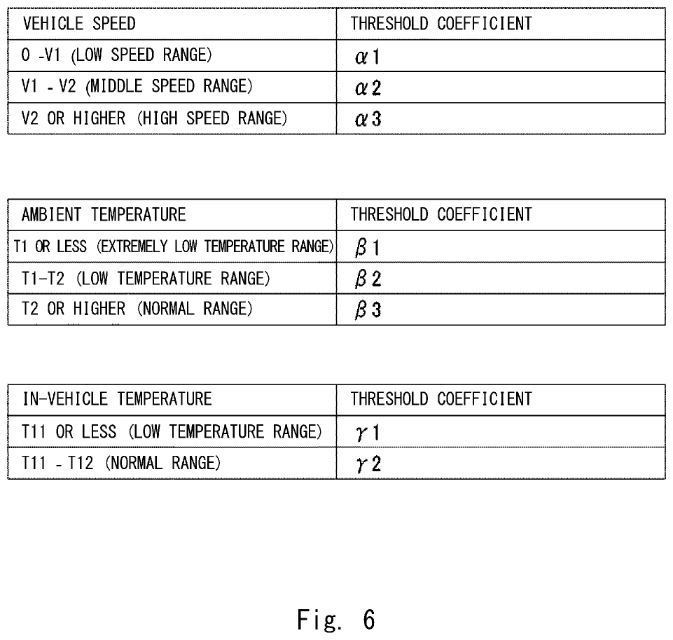

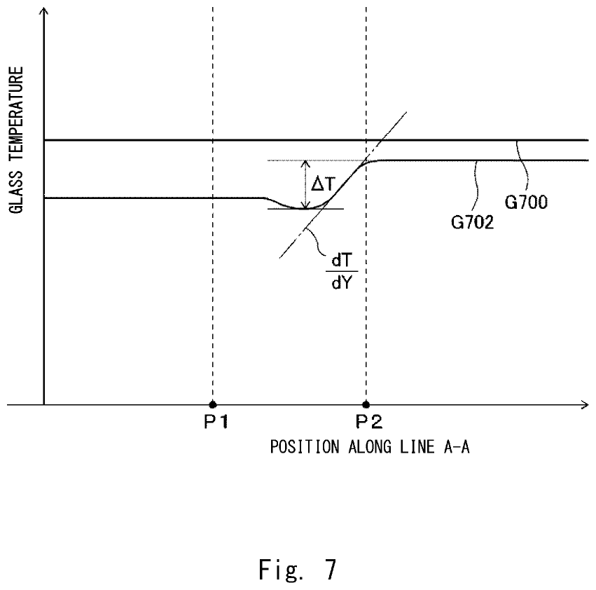

FIG. 5 is a functional diagram showing the functions of the control device 10 (heating control system) associated with the windshield heating control. FIG. 6 is an explanatory diagram of threshold information. FIG. 7 is an explanatory diagram of a cause of a defect (for example, a crack) which may occur in a third region 133, which will be described later.

The control device 10 (heating control system) includes a sensor information acquisition unit (circuit) 150, a control information storage unit 151, and a control processing unit (circuit) 152, as shown in FIG. 5. The sensor information acquisition unit 150 and the control processing unit 152 can be implemented by the above-described CPU 11 executing one or more programs in the storage device (for example, the ROM 13). The control information storage unit 151 can be implemented by a storage device (e.g., the ROM 13, the auxiliary storage device 14, etc.).

The sensor information acquisition unit 150 acquires various sensor information related to the window glass 50 from the first temperature sensor 71, the second temperature sensor 72, the first humidity sensor 76, and the second humidity sensor 77. The sensor information acquisition unit 150 acquires the vehicle speed information, the ambient temperature information, and the in-vehicle temperature information (these three types of information are hereinafter collectively referred to as “environmental information”) via the in-vehicle network 31. The sensor information acquisition unit 150 may acquire various types of sensor information at predetermined intervals.

The control information storage unit 151 stores control information used in the windshield heating control. In this embodiment, the control information includes the threshold information for setting a threshold (a threshold Th described later). Details of the threshold information will be described later.

The control processing unit 152 performs control processing for controlling the first heating device 61 and the second heating device 62 based on various sensor information acquired by the sensor information acquisition unit 150. Specifically, the control processing unit 152 controls the switch unit 614 to be turned on or off based on the various sensor information acquired by the sensor information acquisition unit 150, thereby causing the state of the first heating elements 610 to transition between an energized state and a non-energized state. The control processing unit 152 controls the switch unit 624 to be turned on or off based on the various sensor information acquired by the sensor information acquisition unit 150, thereby causing the state of the second heating elements 620 to transition between the energized state and the non-energized state.

As shown in FIG. 5, the control processing unit 152 includes a first energization processing unit (circuit) 1521, a second energization processing unit (circuit) 1522, a threshold setting processing unit 1523, a temperature difference parameter calculation unit (circuit) 1524, a threshold determination processing unit 1525, and a temperature difference reduction processing unit (circuit) 1526.

The first energization processing unit 1521 executes first energization processing for energizing the first heating elements 610 based on the sensor information from the first temperature sensor 71 and the first humidity sensor 76 so that dew condensation (including fogging) does not occur in the first region 131.

For example, the first energization processing unit 1521 calculates a dew point temperature (hereinafter also referred to as a “first dew point temperature”) at which dew condensation begins to occur in the first region 131 based on the sensor information from the first temperature sensor 71 and the first humidity sensor 76. When the glass temperature of the first region 131 based on the sensor information from the first temperature sensor 71 is lower than or equal to a first energization start threshold corresponding to the first dew point temperature, the first energization processing unit 1521 energizes the first heating elements 610. The first energization start threshold may be the first dew point temperature or may be higher than the first dew point temperature by a certain margin. When the energization is started in this manner, the first energization processing unit 1521 stops energization of the first heating elements 610 when the glass temperature of the first region 131 based on the sensor information from the first temperature sensor 71 becomes higher than or equal to a first energization end threshold corresponding to the first dew point temperature. The first energization end threshold may be slightly higher than the first dew point temperature. However, in the modified example, the first energization end threshold may be the same as the first energization start threshold.

The second energization processing unit 1522 executes second energization processing for energizing the second heating elements 620 based on the sensor information from the second temperature sensor 72 and the second humidity sensor 77 so that dew condensation does not occur in the second region 132.

For example, the second energization processing unit 1522 calculates a dew point temperature (hereinafter also referred to as a “second dew point temperature”) at which dew condensation begins to occur in the second region 132 based on the sensor information from the second temperature sensor 72 and the second humidity sensor 77. When the glass temperature of the second region 132 based on the sensor information from the second temperature sensor 72 is lower than or equal to a second energization start threshold corresponding to the second dew point temperature, the second energization processing unit 1522 energizes the second heating elements 620. The second energization start threshold may be the second dew point temperature or may be higher than the second dew point temperature by a certain margin. When the energization is started in this manner, the second energization processing unit 1522 stops energization of the second heating elements 620 when the glass temperature of the second region 132 based on the sensor information from the second temperature sensor 72 becomes higher than or equal to a second energization end threshold corresponding to the second dew point temperature. The second energization end threshold may be slightly higher than the second dew point temperature. However, in the modified example, the second energization end threshold may be the same as the second energization start threshold.

The threshold setting processing unit 1523 sets a threshold (hereinafter a “threshold Th” will be used to distinguish this threshold from other thresholds) based on the environmental information (the vehicle speed information, the ambient temperature information, and the in-vehicle temperature information) acquired by the sensor information acquisition unit 150. Although the threshold Th may be constant, it is a variable value set based on the threshold information in this embodiment. When the threshold Th is constant, the threshold information in the control information storage unit 151 and the threshold setting processing unit 1523 are omitted. The threshold Th is a threshold related to a condition for executing temperature difference reduction processing to be executed by the temperature difference reduction processing unit 1526, and is compared with a value of a temperature difference parameter, as described later in detail. An example of a specific method for setting the threshold Th will be described later.

The temperature difference parameter calculation unit 1524 calculates the value of the temperature difference parameter based on the sensor information from each of the first temperature sensor 71 and the second temperature sensor 72 acquired by the sensor information acquisition unit 150. The temperature difference parameter indicates a temperature difference between the glass temperature of the third region 133 of the window glass 50 and the glass temperature of the first region 131 or the glass temperature of the second region 132.

The third region 133 includes a region in which a defect (e.g., a crack) may occur in the window glass 50 due to the temperature difference (the temperature difference between the glass temperature of the third region 133 and a higher one of the glass temperature of the first region 131 and that of the second region 132) caused by the first energization processing and the second energization processing described above, among the regions that do not even partially belong to either the first region 131 or the second region 132 (i.e., the regions including no heating element). The third region 133 is typically a region having a certain area, but may be a region having a relatively small area.

In this embodiment, for example, the third region 133 is the entire region between the first region 131 and the second region 132 in the Y direction, and will hereinafter be referred to as the “third region 133”. Note that in the modified example, the third region 133 may be a part of the region between the first region 131 and the second region 132. The region between the first region 131 and the second region 132 in the Y direction may be a set of positions overlapping both the first region 131 and the second region 132 in the Y direction. In this embodiment, the boundary position of the third region 133 in the X direction is substantially the same as the position of the second region 132 in the X direction.

Since the third region 133 is positioned between the first region 131 and the second region 132 and no heating element is provided therein, the glass temperature is likely to be significantly lower than the respective glass temperatures of the first region 131 and the second region 132.

Hereinafter, the “glass temperature of the third region 133” is assumed to be a minimum value of the glass temperature at each position of the third region 133, unless otherwise noted. Further, with respect to the temperature difference between the glass temperature of the third region 133 and each of the glass temperatures of the first region 131 and the second region 132, the glass temperatures of the first region 131 and the second region 132 are glass temperatures determined in accordance with the sensor information from the first temperature sensor 71 and the second temperature sensor 72, respectively. The temperature difference between the glass temperature of the third region 133 and the glass temperature of the first region 131 or the glass temperature of the second region 132 refers to a temperature difference between the glass temperature of the third region 133 and a higher one of the glass temperature of the first region 131 and the glass temperature of the second region 132. This is because defects (for example, cracks) are likely to occur in the window glass 50 when the temperature difference is large. Therefore, the term “temperature difference between the temperature of the third region 133 and the temperature of the first region 131 or the temperature of the second region 132” is used to indicate the temperature difference between the glass temperature of the third region 133 and the glass temperature of the first region 131 or the second region 132, whichever is higher.

The larger the temperature gradient (see the temperature gradient dT/dY in FIG. 7), the more likely a defect (for example, a crack) in the window glass 50 caused by the temperature difference between regions is likely to occur. In FIG. 7, two examples (characteristic G700 and characteristic G702) of the change characteristics of the glass temperature along the line A-A of FIG. 2 are shown, where the horizontal axis represents the positions along the line A-A of FIG. 2 and the vertical axis represents the glass temperature. In FIG. 7, the closer the position on the horizontal axis it is to the right direction, the closer it is to the upper side in the Y direction, and a position P1 corresponds to the boundary position between the first region 131 and the third region 133, while a position P2 corresponds to the boundary position between the third region 133 and the second region 132. The characteristic G700 is an example of a characteristic when there is substantially no temperature difference, and the characteristic G702 is an example of a characteristic that may cause a defect (for example, a crack) in the window glass 50. In FIG. 7, ΔT corresponds to the temperature difference between the temperature of the third region 133 and the first region 131 or the temperature of the second region 132. Commonly, when the distance in the Y direction between the positions P1 and P2 is the same (i.e., when the length of the third region 133 in the Y direction is the same), the larger the ΔT, the larger the gradient dT/dY tends to be.

The method of calculating the value of the temperature difference parameter by the temperature difference parameter calculation unit 1524 may be any method. In this embodiment, the value of the temperature difference parameter may be calculated in any mode based on each value of a predetermined input parameter including the sensor information from the first temperature sensor 71 and the second temperature sensor 72. For example, it is possible to input each value of the predetermined input parameter and output (generate) the value of the temperature difference parameter by using artificial intelligence. This can be done by implementing a convolutional neural network derived from machine learning when artificial intelligence is used. In the machine learning, the weight or the like of the convolutional neural network that minimizes an error in the value of the temperature difference parameter is learned using actual data related to the temperature difference. In this case, the predetermined input parameter may be any parameter that affects the temperature difference between the temperature of the third region 133 and the temperature of the first region 131 or the temperature of the second region 132, such as the glass temperature of the first region 131, the glass temperature of the second region 132, the difference between these glass temperatures, the vehicle speed, the ambient temperature, the in-vehicle temperature, and so on.

The temperature difference parameter need not be a parameter directly indicating the temperature difference between the temperature of the third region 133 and the temperature of the first region 131 or the temperature of the second region 132, and instead may be a parameter indirectly indicating the temperature difference. For example, the temperature difference parameter may be a parameter indicating a gradient of a change in the glass temperature of the third region 133 and the glass temperature of the first region 131 or the glass temperature of the second region 132 (a rate of change in the glass temperature per unit distance, see the temperature gradient dT/dY in FIG. 7) between the third region 133 and the first region 131 or the second region 132.

In this embodiment, as an example, the temperature difference parameter is a difference between the glass temperatures indicated by the respective pieces of the sensor information from the first temperature sensor 71 and the second temperature sensor 72. That is, the temperature difference parameter is a difference between the glass temperature of the first region 131 and the glass temperature of the second region 132. Note that, as described above with reference to FIG. 7, a parameter that directly contributes to a defect (for example, a crack) in the window glass 50 is the temperature gradient dT/dY, and the difference between the glass temperature of the first region 131 and the glass temperature of the second region 132 is a parameter that correlates with the temperature gradient dT/dY. That is, the larger the difference between the glass temperature of the first region 131 and the glass temperature of the second region 132, the larger the temperature gradient dT/dY tends to become. However, in the modified example, the value of the temperature difference parameter may be derived by correcting the value of the difference between the glass temperature of the first region 131 and the glass temperature of the second region 132 to a value that more accurately represents the temperature gradient dT/dY.

The threshold determination processing unit 1525 determines whether or not the condition for executing the temperature difference reduction processing to be executed by the temperature difference reduction processing unit 1526 is satisfied. Specifically, the threshold determination processing unit 1525 determines whether or not the value of the temperature difference parameter calculated by the temperature difference parameter calculation unit 1524 exceeds the threshold Th set by the threshold setting processing unit 1523. In this case, the condition for executing the temperature difference reduction processing to be executed by the temperature difference reduction processing unit 1526 is satisfied when the value of the temperature difference parameter exceeds the threshold Th.

The temperature difference reduction processing unit 1526 executes the temperature difference reduction processing when the condition for executing the temperature difference reduction processing is satisfied (that is, when the value of the temperature difference parameter exceeds the threshold Th). The temperature difference reduction processing is for preventing the temperature difference (hereinafter also referred to simply as “local temperature difference in the window glass 50”) between the glass temperature of the third region 133 and the glass temperature of the first region 131 or the glass temperature of the second region 132 from exceeding an upper limit value. Specifically, the temperature difference reduction processing is for controlling at least one of the first heating elements 610 and the second heating elements 620 so that the local temperature difference in the window glass 50 does not exceed the upper limit value.

The upper limit value corresponds to the local temperature difference in the window glass 50 when a defect (for example, a crack) related to the third region 133 of the window glass 50 occurs. For example, when the local temperature difference in the window glass 50 is within a certain range and a defect (for example, a crack) related to the third region 133 of the window glass 50 occurs, the upper limit value corresponds to a lower limit value of the range.

For example, in the first region 131 and the second region 132, if the glass temperature of the first region 131 is significantly lower than the glass temperature of the second region 132, the temperature difference reduction processing unit 1526 may control the first heating elements 610 and the second heating elements 620 so that the glass temperature of the first region 131 rises and/or the rise in the glass temperature of the second region 132 is suppressed. This can reduce the possibility of a defect in the window glass 50 (a defect in the third region 133 of the window glass 50) occurring due to the fact that the glass temperature of the first region 131 is significantly lower than the glass temperature of the second region 132.

The temperature difference reduction processing is executed for the local temperature difference in the window glass 50 caused by execution of either or both of the first energization processing and the second energization processing. The reason for this is described below. The first energization processing and the second energization processing are executed so as not to cause dew condensation in the first region 131 and the second region 132, respectively, as described above. However, the first energization processing and the second energization processing tend to increase the local temperature difference in the window glass 50, because they are accompanied by an increase in the glass temperature.

Here, when the cover 4 (see FIG. 3) covering the second region 132 from the passenger compartment side is provided as in this embodiment, the humidity in the second region 132 tends to increase. Therefore, the second dew point temperature tends to be higher than the first dew point temperature. Accordingly, at a certain time point, the second energization start threshold and the second energization end threshold are almost always greater than or equal to the first energization start threshold and the first energization end threshold, respectively. Therefore, in a situation where the vehicle peripheral monitoring sensor 20 should function, a state in which only the second energization processing is being executed occurs, but a state in which only the first energization processing is being executed does not occur substantially. Therefore, in this embodiment, the condition for executing the temperature difference reduction processing is basically established in a state where the second energization processing is being executed. That is, the temperature difference reduction processing is executed so that the glass temperature of the first region 131 rises and/or the rise in the glass temperature of the second region 132 is suppressed in a state where the second energization processing is being executed.

For example, the temperature difference reduction processing may include starting the energization of the first heating elements 610 without executing the first energization processing (i.e., even if the glass temperature of the first region 131 is higher than the first energization start temperature) when the glass temperature of the first region 131 is lower than the glass temperature of the second region 132 in the first region 131 and the second region 132. In this case, the local temperature difference in the window glass 50 can be reduced by increasing the glass temperature of the first region 131.

Furthermore, the temperature difference reduction processing may include continuing the energization of the first heating elements 610 regardless of whether or not a condition to end the first energization processing is satisfied (i.e., even if the glass temperature of the first region 131 is higher than the first energization end temperature) when the glass temperature of the first region 131 is lower than the glass temperature of the second region 132 in the first region 131 and the second region 132. In this case, the local temperature difference in the window glass 50 can be reduced by increasing the glass temperature of the first region 131.

As described above, according to this embodiment, when the value of the temperature difference parameter exceeds the threshold Th in a state where the second energization processing is being executed, the temperature difference reduction processing is executed, so that the local temperature difference in the window glass 50 can be reduced. Thus, defects (for example, cracks) in the window glass 50 that may occur due to a significant local temperature difference in the window glass 50 can be effectively reduced in the state where the second energization processing is being executed.

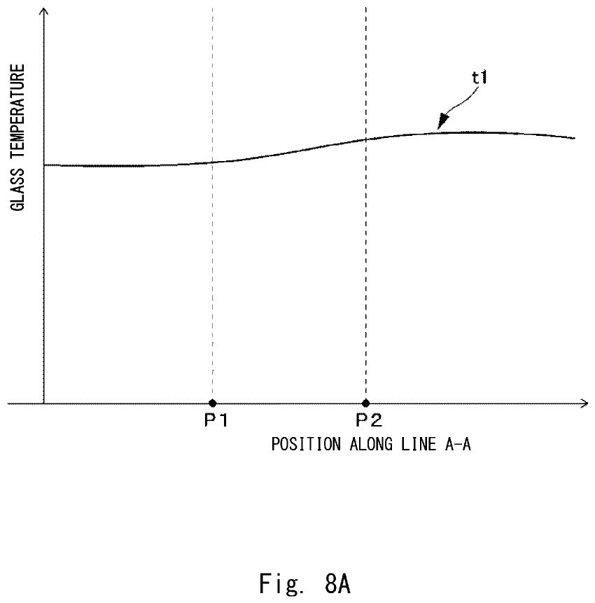

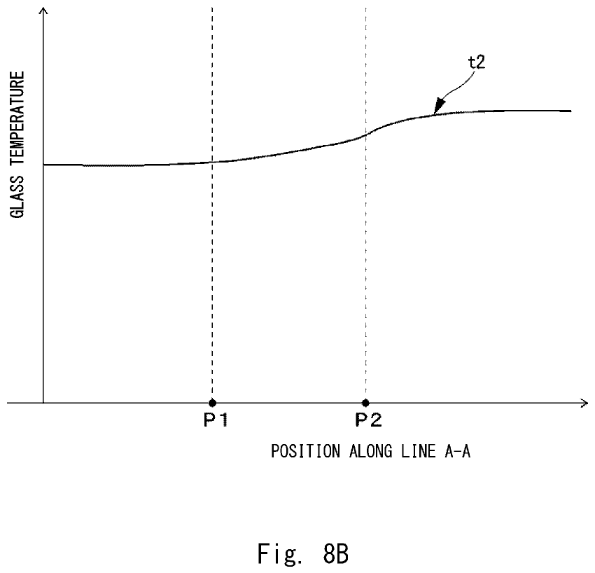

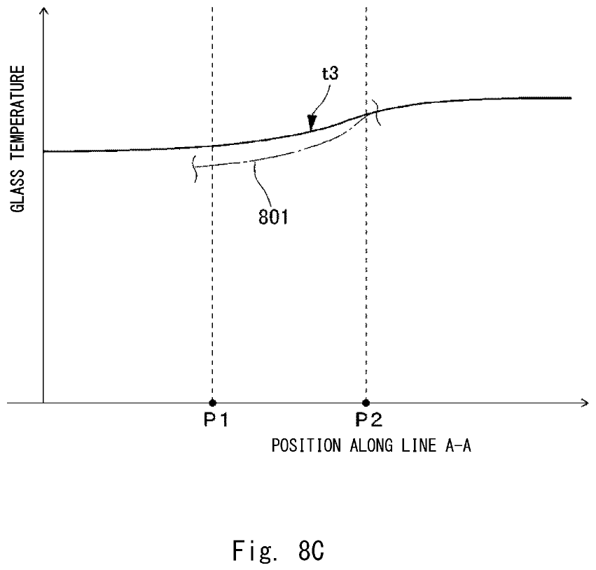

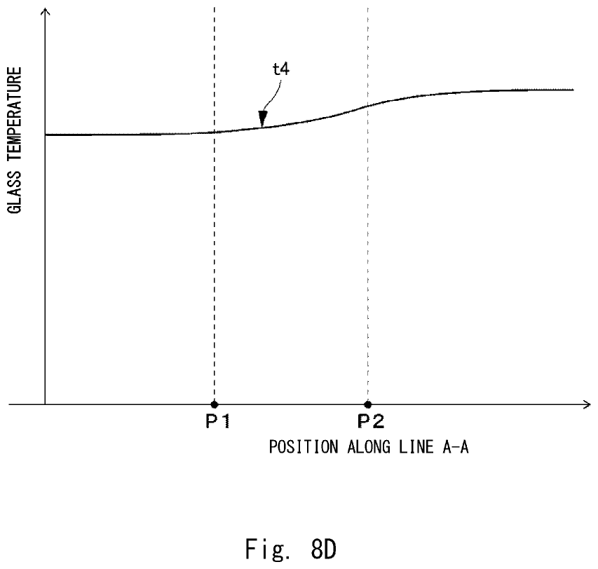

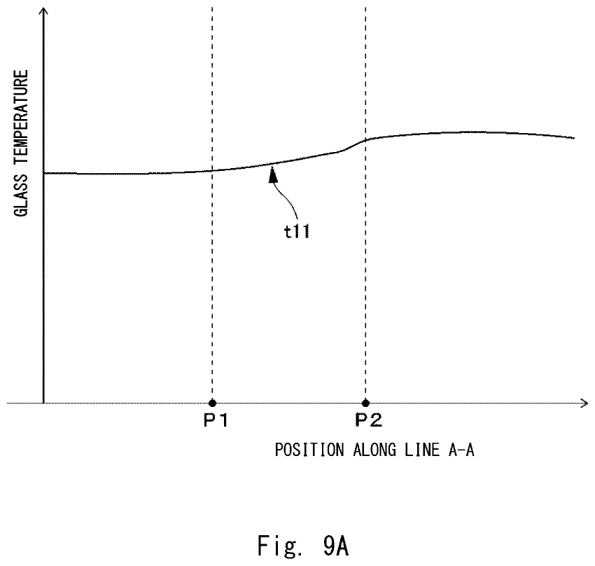

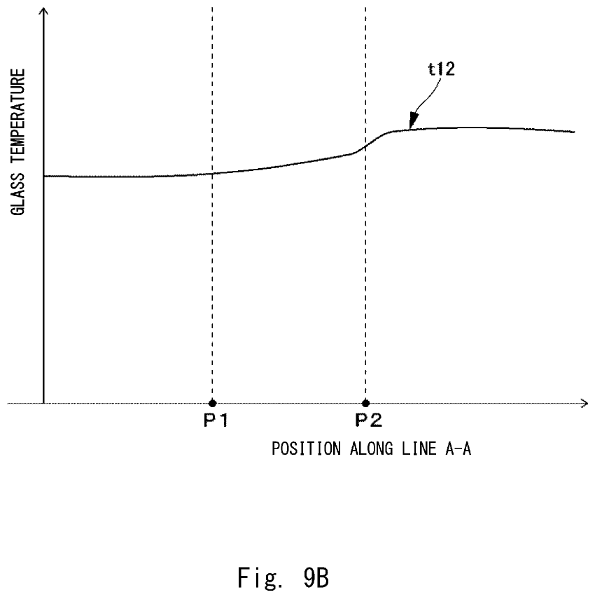

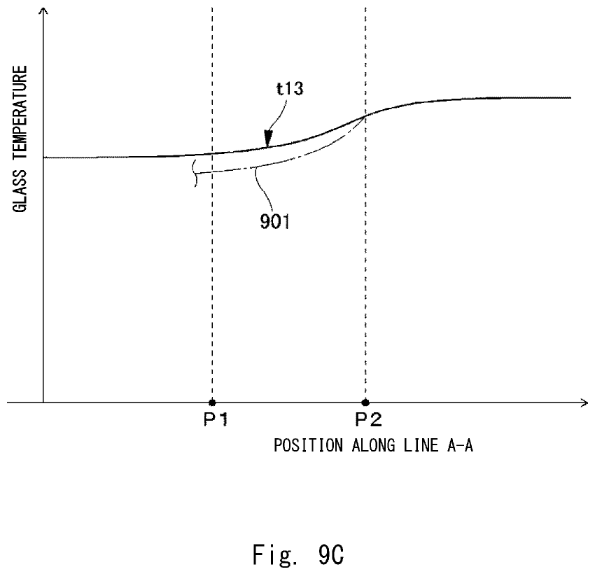

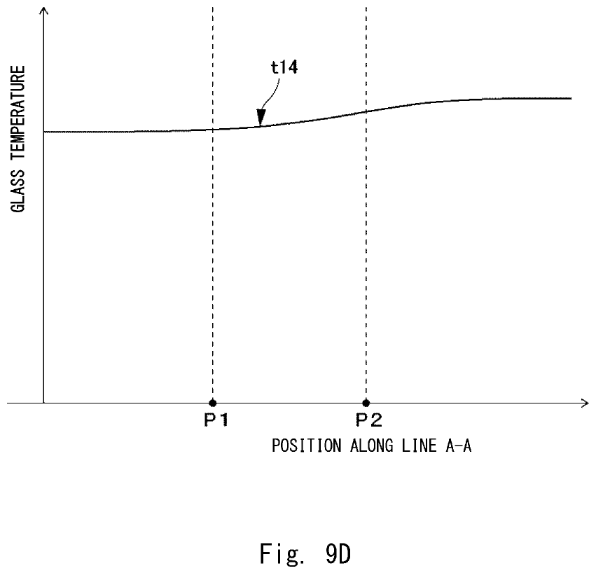

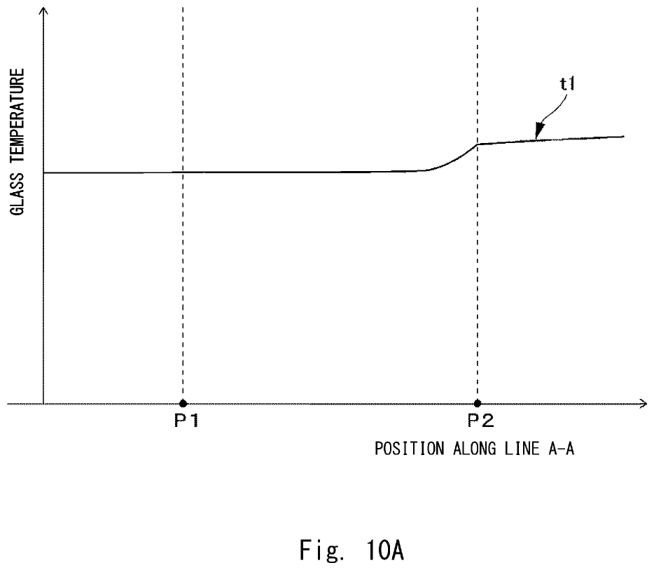

Next, the effects of this embodiment will be described with reference to FIGS. 8A to 9D.

FIGS. 8A to 8D are explanatory diagrams for the case where the temperature difference reduction processing is executed in a situation where only the second energization processing is being executed, and explanatory diagrams showing examples of the relationship between the glass temperatures of the first region 131 and the second region 132 and the glass temperature of the third region 133. In FIGS. 8A to 8D, an example of the change characteristic (hereinafter referred to simply as “change characteristic”) of the glass temperature along the line A-A of FIG. 2 are shown, where the horizontal axis represents the positions along the line A-A of FIG. 2 and the vertical axis represents the glass temperature. In FIGS. 8A to 8D, the closer the position on the horizontal axis it is to the right direction, the closer it is to the upper side in the Y direction, and a position P1 corresponds to the boundary position between the first region 131 and the third region 133, while a position P2 corresponds to the boundary position between the third region 133 and the second region 132.

FIGS. 8A to 8D show change characteristics from different time points t1 to t4, respectively.

The time point t1 is an initial state and corresponds to a time point when the glass temperature of the second region 132 becomes lower than or equal to the second energization start threshold. In FIG. 8A, at the time point t1, the glass temperature of the second region 132 is higher than the glass temperature of the first region 131.

The time point t2 is a time point after the time point t1, and corresponds to a time point after a certain period of time has passed since the second energization processing is started. As described above, at the time point t2, the glass temperature of the second region 132 is significantly higher than the glass temperature of the first region 131 due to the second energization processing compared to those at the time point t1, and therefore the local temperature difference in the window glass 50 is relatively large.

In this manner, in a situation where only the second energization is executed, the local temperature difference in the window glass 50 tends to be relatively large. In FIG. 8B, right after the time point t2, the value of the temperature difference parameter exceeds the threshold Th, and the temperature difference reduction processing is started. That is, energization of the first heating elements 610 is started right after the time point t2, even though the glass temperature of the first region 131 is higher than or equal to the first energization start temperature.

The time point t3 is a time point after the time point t2, and corresponds to a time point after a certain period of time has passed since the temperature difference reduction processing is started. As shown in FIG. 8C, by starting the temperature difference reduction processing, the local temperature difference in the window glass 50 is reduced. At the time point t3, the second energization processing started at time point t1 is still continued.

The time point t4 is after the time point t3, and corresponds to a time point at which the second energization processing started at the time point t1 is normally completed (i.e., corresponds to a time point at which the glass temperature of the second region 132 becomes higher than or equal to the second energization end threshold). When the time point t4 is reached, as shown in FIG. 8D, the temperature difference reduction processing started right after the time point t2 is also ended in response to the completion of the second energization processing (since it is unlikely that the local temperature difference in the window glass 50 will further increase thereafter). That is, the steady state is reached. In the modified example, the temperature difference reduction processing may instead be completed before the time point t4 is reached.

In FIG. 8C, a change characteristic 801 in a comparative example in which the temperature difference reduction processing from right after the time point t2 is not executed is indicated by the chain line in association with the change characteristic (solid line) at the time point t3. In such a comparative example, the local temperature difference in the window glass 50 is further increased as shown by the change characteristic 801. That is, defects (for example, cracks) in the window glass 50 may occur.

On the other hand, according to this embodiment, since the temperature difference reduction processing is executed in a situation where only the second energization processing is being executed (in a situation where the condition for executing the first energization processing is not satisfied) as described above, the possibility of a defect (for example, a crack) in the window glass 50 can be effectively reduced.

FIGS. 9A to 9D are explanatory diagram for the case where the temperature difference reduction processing is executed in a state where the first energization processing and the second energization processing are executed and, in a manner similar to FIGS. 8A to 8D, show change characteristics at different time points t11 to t14, respectively. Here, as a preferred example, it is assumed that the second heating elements 620 have a higher heat generation density than that of the first heating elements 610 as described above.

The time point t11 is an initial state, and corresponds to a time point when the glass temperature of the first region 131 is lower than or equal to the first energization start threshold and the glass temperature of the second region 132 is lower than or equal to the second energization start threshold. Note that in FIG. 9A, the glass temperature of the second region 132 is higher than the glass temperature of the first region 131 at the time point t11.

The time point t12 is a time point after the time point t11, and corresponds to a time point after a certain period of time has passed since the first energization processing and the second energization processing are started. At the time point t12, the first energization processing and the second energization processing started at time point t11 are still continued.

At the time point t12, the glass temperature of the second region 132 is greatly higher than the glass temperature of the first region 131, because the second heating elements 620 have a higher heat generation density than that of the first heating elements 610 compared to those at the time point t11, and therefore the local temperature difference in the window glass 50 is relatively large.

In this way, if the second heating elements 620 have a higher heat generation density than that of the first heating elements 610, the local temperature difference in the window glass 50 is likely to be relatively large even in a situation where both the first energization processing and the second energization processing are executed. In FIG. 9B, right after the time point t12, the value of the temperature difference parameter exceeds the threshold value Th, and the condition for executing the temperature difference reduction processing is satisfied. Therefore, even if the glass temperature of the first region 131 reaches or exceeds the first energization end temperature right after the time point t12, the energization of the first heating elements 610 is maintained by the temperature difference reduction processing. In FIG. 9B, right after the time point t2, in a situation where the value of the temperature difference parameter exceeds the threshold Th, when the glass temperature of the first region 131 becomes higher than or equal to the first energization end temperature, the temperature difference reduction processing in place of the first energization processing is started.

The time point t13 is a time point after the time point t12, and corresponds to a time point after a certain period of time has passed since the temperature difference reduction processing is started. As shown in FIG. 9C, by starting the temperature difference reduction processing, the local temperature difference in the window glass 50 is reduced. At the time point t13, the second energization processing started at time point t1 is still continued.

The time point t14 is after the time point t13, and corresponds to a time point at which the second energization processing started at the time point t11 is normally completed (i.e., corresponds to a time point at which the glass temperature of the second region 132 becomes higher than or equal to the second energization end threshold). When the time point t14 is reached, as shown in FIG. 9D, the temperature difference reduction processing started right after the time point t12 is also ended in response to the completion of the second energization processing (since it is unlikely that the local temperature difference in the window glass 50 will further increase thereafter). That is, the steady state is reached. In the modified example, the temperature difference reduction processing may instead be completed before the time point t14 is reached.

In FIG. 9C, a change characteristic 901 in the comparative example in which the temperature difference reduction processing from right after the time point t2 is not executed is indicated by the chain line in association with the change characteristic (solid line) at the time point t13. In such a comparative example, the local temperature difference in the window glass 50 is further increased as shown by the change characteristic 901. That is, defects (for example, cracks) in the window glass 50 may occur.

On the other hand, according to this embodiment, as described above, in a state where the first energization processing and the second energization processing are executed, the temperature difference reduction processing is executed even when the first energization processing is completed (that is, the first energization processing is substantially extended), so that the possibility of a defect (for example, a crack) in the window glass 50 can be effectively reduced.

In this embodiment, as described above, the temperature difference parameter is the difference between the glass temperature of the first region 131 and the glass temperature of the second region 132, and is not a parameter that directly indicates the temperature difference between the glass temperature of the third region 133 and the glass temperature of the first region 131 or the glass temperature of the second region 132. That is, although the difference between the glass temperature of the first region 131 and the glass temperature of the second region 132 is correlated with the temperature difference between the temperature of the third region 133 and the temperature of the first region 131 or the temperature of the second region 132, the difference between the glass temperature of the first region 131 and the glass temperature of the second region 132 may not match the temperature difference between the temperature of the third region 133 and the temperature of the first region 131 or the temperature of the second region 132.

This tendency (i.e., the tendency for the difference between the respective glass temperatures of the first region 131 and the second region 132, relative to the temperature difference between the third region 133 and the first region 131 or the second region 132, to become larger) occurs when the distance between the first region 131 and the second region 132 is relatively large. Hereinafter, such a tendency will be referred to as “difference increasing tendency according to an increase in the distance between the first region 131 and the second region 132” or “difference increasing tendency”.

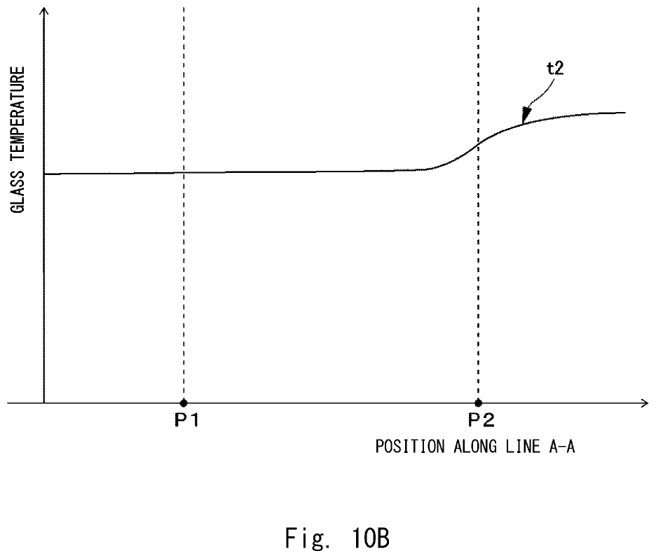

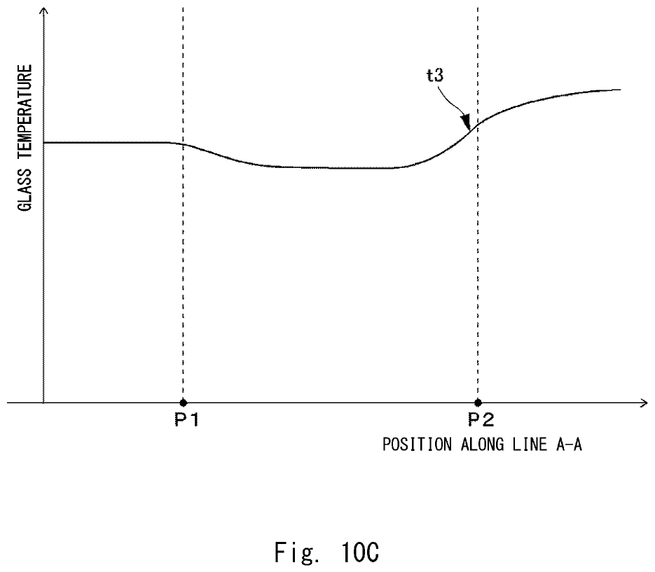

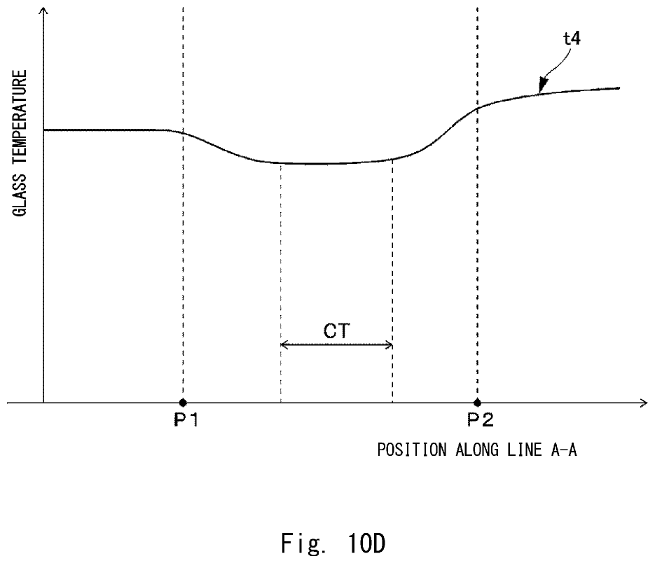

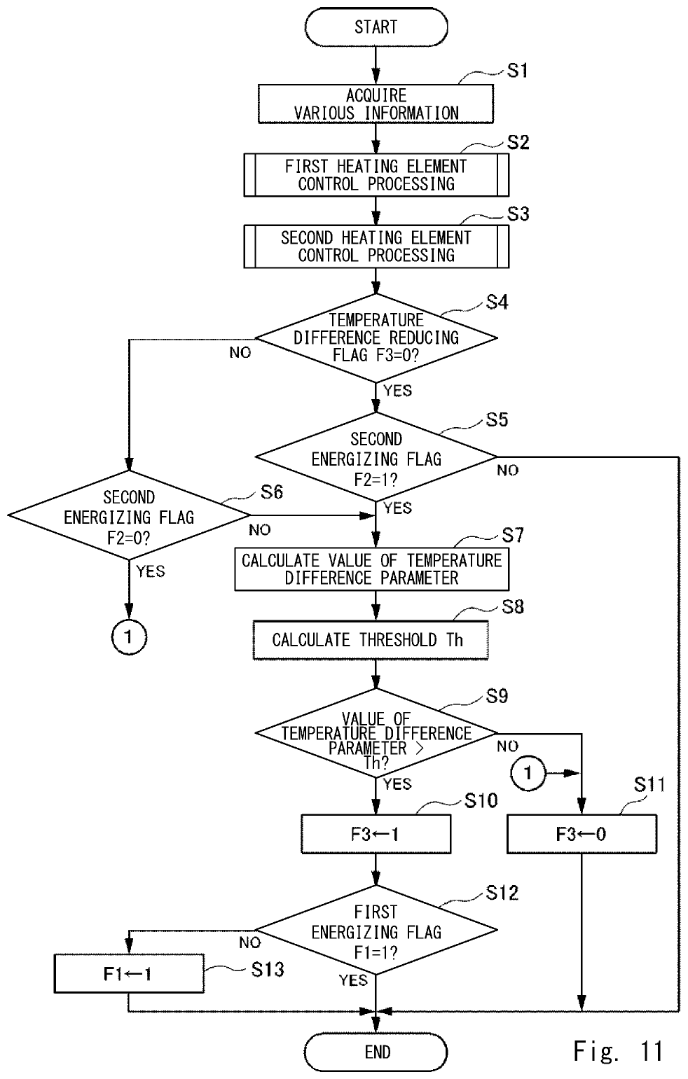

FIGS. 10A to 10D are explanatory diagrams showing the difference increasing tendency according to the increase in the distance between the first region 131 and the second region 132. FIGS. 10A to 10D are diagrams in contrast with FIGS. 8A to 8D described above, and in a manner similar to the case of FIGS. 8A to 8D, show change characteristics when the temperature difference reduction processing is executed in a state in which only the second energization processing is being executed, and the time points t1 to t4 are as described above.

Unlike FIGS. 8A to 8D, FIGS. 10A to 10D show change characteristics when the distance between the first region 131 and the second region 132 is relatively large.

When the distance between the first region 131 and the second region 132 (i.e., the width of the third region 133 in the Y direction) is relatively large in the Y direction, the difference between the glass temperature of the third region 133 and the glass temperature of the first region 131 becomes relatively large as shown in FIGS. 10A to 10D. That is, the heat energy from the first heating elements 610 and the second heating elements 620 is difficult to transfer to the central part (see a section CT of FIG. 10D, and a region 1331 of FIG. 2) of the third region 133 in the Y direction, and the glass temperature there is difficult to rise. Thus, as shown in FIGS. 10A to 10D, the change characteristic of the third region 133 significantly decreases in the central part and then increases as the position changes from the first region 131 side toward the second region 132. The tendency for the change characteristic in the central part to become minimal increases as the distance between the first region 131 and the second region 132 increases.

The tendency of such a change characteristic in the central part to become minimal depends on the heat transfer coefficient (e.g., the heat transfer coefficient from the first region 131 or the second region 132 to the center part) in the third region 133. Unlike the distance between the first region 131 and the second region 132, such a heat transfer coefficient is not constant and instead is changed depending on the temperature of the window glass 50. Therefore, the heat transfer coefficient is changed according to the values (an examples of predetermined information) of environmental parameters that affect the temperature of the window glass 50, such as the vehicle speed, the ambient temperature, the in-vehicle temperature, and the like. For example, as the vehicle speed increases, the temperature of the window glass 50 tends to decrease, and therefore the heat transfer coefficient of, for example, the third region 133 tends to decrease.

Therefore, the value of the temperature difference parameter may be corrected according to the value of the environmental parameter in a mode in which the heat transfer coefficient is taken into consideration. Alternatively or additionally, the above-described threshold Th may be corrected (changed) according to the value of the environmental parameter in a mode in which the heat transfer coefficient is taken into consideration. In this embodiment, as an example, the threshold Th is corrected (changed) according to the value of the environmental parameter.

Specifically, the threshold setting processing unit 1523 may set the threshold Th based on the vehicle speed information so that the threshold Th becomes smaller as the vehicle speed becomes higher. This is because, as described above, as the vehicle speed increases, the temperature of the window glass 50 tends to decrease, and therefore the heat transfer coefficient tends to decrease. Similarly, the threshold setting processing unit 1523 may set the threshold Th based on the ambient temperature information so that the threshold Th becomes smaller as the ambient temperature becomes lower. The threshold setting processing unit 1523 may set the threshold Th based on the in-vehicle temperature information so that the threshold Th becomes smaller as the in-vehicle temperature becomes lower. Thus, even when the heat transfer coefficient of the third region 133 is changed according to a change in the value of the environmental parameter, the threshold Th can be set such that the condition for executing the temperature difference reduction processing is satisfied at an appropriate timing.

For example, in this embodiment, the threshold setting processing unit 1523 refers to the threshold information in the control information storage unit 151 to set the threshold Th corresponding to each value (environmental information) of the three environmental parameters of the vehicle speed, the ambient temperature, and the in-vehicle temperature. In this case, the threshold information indicates the relationship between each value of the three environmental parameters of the vehicle speed, the ambient temperature, and the in-vehicle temperature and the threshold. In the example shown in FIG. 6, threshold coefficients corresponding to values of the three parameters of the vehicle speed, the ambient temperature, and the in-vehicle temperature are shown. For example, a threshold coefficient α1 is associated with the vehicle speed within the range of 0 to V1 (low speed range), and a threshold coefficient α2 is associated with the vehicle speed within the range of V1 to V2 (medium speed range), and so forth. The number of these divisions may be any number, and more detailed divisions may be set. In the case of FIG. 6, the threshold setting processing unit 1523 refers to the threshold information and extracts the threshold coefficients corresponding to the values of the three environmental parameters of the vehicle speed, the ambient temperature, and the in-vehicle temperature based on the environmental information. Then, the threshold setting processing unit 1523 calculates a threshold Th by multiplying the extracted threshold coefficients by a predetermined reference value for calculating the threshold Th. The threshold coefficients may be adapted such that the threshold Th calculated in this way becomes a threshold that satisfies the condition for executing the temperature difference reduction processing at an appropriate timing.

In this embodiment, as an example, the threshold information indicates the threshold coefficients corresponding to the values of the three environmental parameters of the vehicle speed, the ambient temperature, and the in-vehicle temperature, as shown in FIG. 6, but is not limited thereto. The threshold information may be map data defining the threshold Th corresponding to each combination of the values of the three environmental parameters of the vehicle speed, the ambient temperature, and the in-vehicle temperature. Although the three environment parameters are used in this embodiment, only one or two environment parameters may be used, or four or more environment parameters may be used.

As described above, as the distance between the first region 131 and the second region 132 increases, it becomes more difficult for heat from the first heating elements 610 and the second heating elements 620 to transfer to the central part between the first region 131 and the second region 132. When the distance between the first region 131 and the second region 132 is greater than or equal to the predetermined distance, the heat from the first heating elements 610 and the second heating elements 620 is not substantially transferred to the central part between the first region 131 and the second region 132. In such a case, the above-described temperature difference reduction processing substantially fails to function. Therefore, in this embodiment, it is desirable that the distance between the first region 131 and the second region 132 be such a distance that the above-described temperature difference reduction processing can function. Since an upper limit distance (i.e., the predetermined distance described above) for such a distance depends on various characteristic values of the window glass 50 and the like, the upper limit distance can be derived by a test, a simulation or the like.

On the other hand, as the distance between the first region 131 and the second region 132 decreases, the heat from the first heating elements 610 and the second heating elements 620 is more easily transferred transmitted to the third region 133, thereby making a local temperature difference in the window glass 50 more unlikely to occur.

Therefore, this embodiment is suitable when the distance between the first region 131 and the second region 132 is within the range of 10 mm to 200 mm. In this embodiment, as shown in FIG. 2, the distance between the first region 131 and the second region 132 can be defined by a distance L1 in the Y direction. In other words, when the distance between the first region 131 and the second region 132 is 10 mm or less, the vehicle windshield 1 in which local temperature differences in the window glass 50 are unlikely to occur can be achieved. That is, when the distance between the first region 131 and the second region 132 is 10 mm or less, as described with reference to FIGS. 10A to 10D, the tendency for the change characteristics to be extremely small in the central part, as described with reference to FIGS. 10A to 10D, is less likely to occur. It is thus possible to achieve the vehicle windshield 1 in which defects (e.g., cracks) are unlikely to occur. Note that the distance between the first region 131 and the second region 132 may be minimized in order to ensure electrical insulation.

In this case, the window glass 50 preferably has a plane tensile stress of 5 MPa or less in the part related to the third region 133. This is because the lower the residual tensile stress the original glass has, the lower the risk of cracking due to thermal stress. In the window glass 50, the thickness of the glass (e.g., the glass 51b on the passenger compartment side) is preferably 2 mm or less in the part related to the third region 133. This is because such a thin glass has a relatively small heat capacity, and thus a local temperature difference in the window glass 50 can be reduced. This is also because the glass temperature of the third region 133 rises with good responsiveness during the temperature difference reduction processing described above.

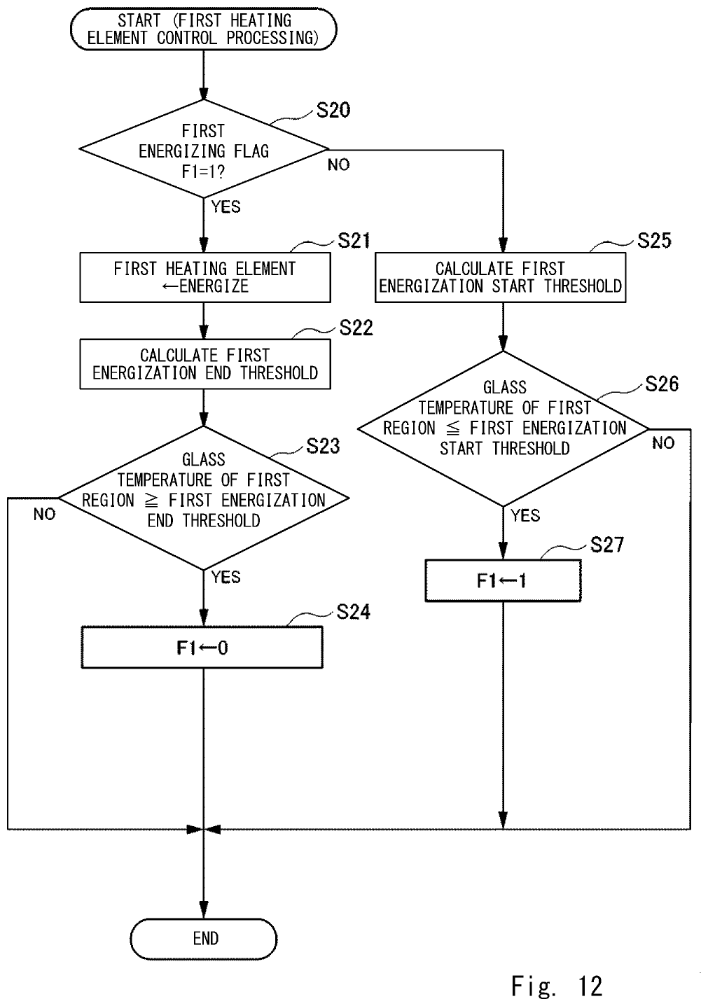

Next, an operation example of the control apparatus 10 according to this embodiment will be described with reference to the flowcharts of FIG. 11 and subsequent drawings. In the subsequent processing flowcharts, the processing order of each step may be replaced as long as the relationship between the input and output of each step is not impaired.

FIG. 11 is an overview flowchart showing an example of processing executed by the control device 10 according to this embodiment in connection with the windshield heating control. The processing shown in FIG. 11 may be repeatedly executed at predetermined intervals when, for example, a vehicle start switch (e.g., an ignition switch) is turned on.

In Step S1, the control device 10 acquires various kinds of information necessary for control. The various kinds of information necessary for the control are as described above in connection with the sensor information acquisition unit 150, and are various kinds of sensor information and environmental information (the vehicle speed information, the ambient temperature information, and the in-vehicle temperature information) related to the window glass 50.

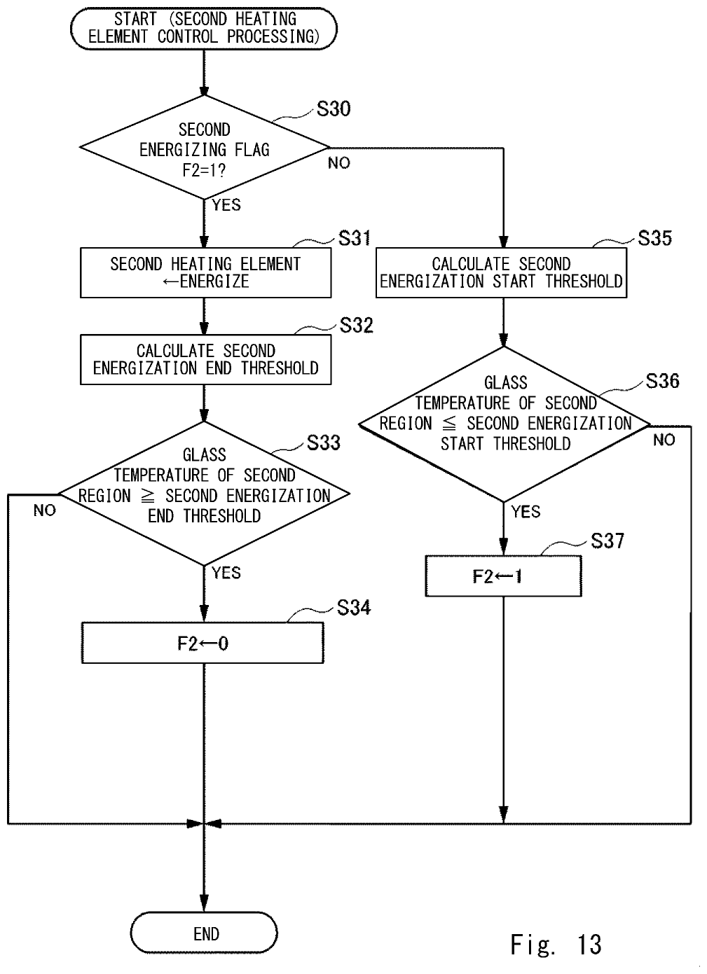

In Step S2, the control device 10 executes first heating element control processing for controlling the first heating elements 610. The first heating element control processing includes the first energization processing described above in connection with the first energization processing unit 1521. An example of the first heating element control processing will be described later with reference to FIG. 12.

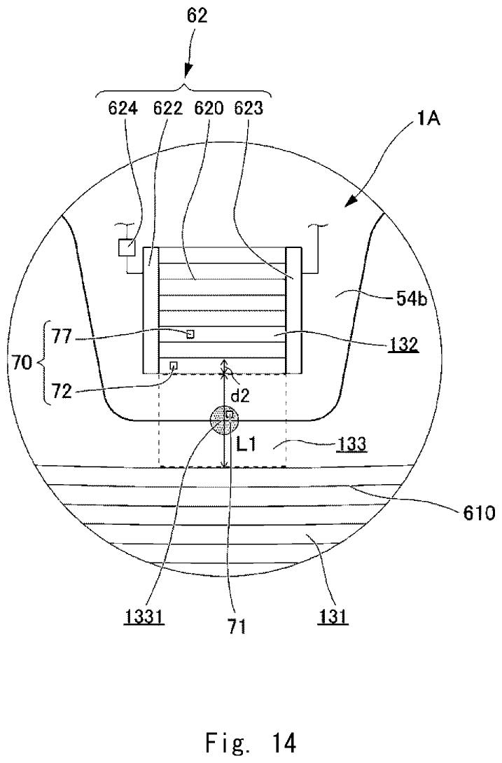

In Step S3, the control device 10 executes second heating element control processing for controlling the second heating elements 620. The second heating element control processing includes the second energization processing described above in connection with the second energization processing unit 1522. An example of the second heating element control processing will be described later with reference to FIG. 13.

In Step S4, the control device 10 determines whether or not a temperature difference reducing flag F3 is “0”. The temperature difference reducing flag F3 is a flag that becomes “1” corresponding to an execution state of the temperature difference reduction processing and becomes “0” corresponding to a non-execution state of the temperature difference reduction processing. If the determination result is “YES”, the processing proceeds to Step S5, otherwise, the processing proceeds to Step S6.

In Step S5, the control device 10 determines whether or not the second energizing flag F2 is “1”. The second energizing flag F2 is a flag that becomes “1” corresponding to the energized state of the second heating elements 620 and becomes “0” corresponding to the non-energized state of the second heating elements 620. If the determination result is “YES”, the processing proceeds to Step S7, otherwise, the processing of the current cycle ends.

In Step S6, the control device 10 determines whether or not the second energizing flag F2 is “0”. If the determination result is “YES”, the processing proceeds to Step S11; otherwise, the processing proceeds to Step S7.

In Step S7, the control device 10 calculates the value of the temperature difference parameter based on the various information obtained in Step S1. The temperature difference parameter is as described above in connection with the temperature difference parameter calculation unit 1524.

In Step S8, the control device 10 calculates (sets) the threshold Th based on the various information obtained in Step S1 and the threshold information. The threshold information is as described above in connection with the control information storage unit 151, and the threshold Th is as described above in connection with the threshold setting processing unit 1523.

In Step S9, the control device 10 determines whether or not the value of the temperature difference parameter obtained in Step S7 exceeds the threshold Th obtained in Step S8. If the determination result is “YES”, the processing proceeds to Step S10, otherwise, the processing proceeds to Step S11.

In Step S10, the control device 10 sets or maintains the temperature difference reducing flag F3 to “1”.

In Step S11, the control device 10 resets or maintains the temperature difference reducing flag F3 to “0”.

In Step S12, the control device 10 determines whether or not the first energizing flag F1 is “1”. The first energizing flag F1 is a flag that becomes “1” corresponding to the energized state of the first heating elements 610 and becomes “0” corresponding to the non-energized state of the first heating elements 610. If the determination result is “YES”, the processing of the current cycle ends, otherwise, the processing proceeds to Step S13.

In Step S13, the control device 10 sets the first energizing flag F1 to “1”. That is, the control device 10 changes the first energizing flag F1 from “0” to “1”.

FIG. 12 is an overview flowchart showing an example of the first heating element control processing (Step S2 of FIG. 11).

In Step S20, the control device 10 determines whether or not the first energizing flag F1 is “1”. If the determination result is “YES”, the processing proceeds to Step S21, otherwise, the processing proceeds to Step S25.

In Step S21, the control device 10 turns on the switch unit 614 to thereby energize the first heating elements 610.

In Step S22, the control device 10 calculates the first energization end threshold based on the various information obtained in Step 51. The first energization end threshold is as described above.

In Step S23, the control device 10 determines whether the glass temperature of the first region 131 based on the various information obtained in Step 51 is higher than or equal to the first energization end threshold obtained in Step S22. If the determination result is “YES”, the processing proceeds to Step S24, otherwise, the processing of the current cycle ends.

In Step S24, the control device 10 resets the first energizing flag F1 to “0”.

In Step S25, the control device 10 calculates the first energization start threshold based on the various information obtained in Step S1. The first energization start threshold is as described above.

In Step S26, the control device 10 determines whether or not the glass temperature of the first region 131 based on the various information obtained in Step S1 is lower than or equal to the first energization start threshold obtained in Step S25. If the determination result is “YES”, the processing proceeds to Step S27, otherwise, the processing of the current cycle ends.

In Step S27, the control device 10 sets the first energizing flag F1 to “1”.

FIG. 13 is an overview flowchart showing an example of the second heating element control processing (Step S3 of FIG. 11). The description of the flowchart of the second heating element control processing of FIG. 13 is substantially the same as the description of the flowchart of the first heating element control processing of FIG. 12, except that in the following description of the flowchart in FIG. 13, the word “second” replaces the word “first” in the description of the flowchart in FIG. 12, and therefore a detailed description of the flowchart in FIG. 13 will be omitted.

According to the processing shown in FIGS. 11 to 13, when the value of the temperature difference parameter exceeds the threshold Th (“YES” in Step S9) in a state in which the second energization processing unit 1522 executes the second energization processing (“YES” in Step S5), the value of the first energizing flag F1 is changed to “1” even if it is “0” (Step S13). In this case, the first heating elements 610 are energized (Step S21), so that the temperature difference reduction processing is achieved. That is, in the processing shown in FIGS. 11 to 13, the energization of the first heating elements 610 (Step S21) caused by a change of the first energizing flag F1 to “1” in Step S13 becomes the temperature difference reduction processing. Therefore, according to the processing shown in FIGS. 11 to 13, the possibility of a defect (e.g., a crack) in the window glass 50 can be effectively reduced by achieving the temperature difference reduction processing in the state where the second energization processing is being executed by the second energization processing unit 1522. In the processing shown in FIGS. 11 to 13, the temperature difference reduction processing is achieved in Step S21 by forcibly changing the state of the first energizing flag F1 in Step S13, but the present disclosure is not limited thereto. For example, when the temperature difference reducing flag F3 is “1”, the first energization end threshold calculated in Step S22 may be corrected to a larger value to achieve the temperature difference reduction processing in Step S21. When the temperature difference reducing flag F3 is “1”, the first energization start threshold calculated in Step S25 may be corrected to a smaller value to achieve the temperature difference reduction processing in Step S21.

In the processing shown in FIGS. 11 to 13, the temperature difference reduction processing is ended when the value of the temperature difference parameter becomes less than or equal to the threshold Th (“NO” in Step S9) or when the energization of the second heating elements 620 is ended (“YES” in Step S6). However, the present disclosure is not limited to this. The temperature difference reduction processing may be ended only when either of these two conditions is satisfied, or other conditions may be added.

### Second Embodiment

In the following description of a second embodiment, components which may be the same as those of the first embodiment may be denoted by the same reference signs and the description thereof may be omitted. Furthermore, the components which are not particularly described may be the same as those of the first embodiment described above.

FIG. 14 is an enlarged diagram of a part of a vehicle windshield 1A according to the second embodiment, and is a view showing a part corresponding to the Q1 part of FIG. 1.

In the vehicle windshield 1A according to the second embodiment, the position of the first temperature sensor 71 is different from that of the vehicle windshield 1 according to the first embodiment. Specifically, in this embodiment, the first temperature sensor 71 is provided within the third region 133 as shown in FIG. 14. That is, the first temperature sensor 71 is provided at a predetermined position away from the first region 131 and the second region 132. The predetermined position is preferably a position of the third region 133 where the temperature difference between the temperature of the third region 133 and that of the first region 131 or that of the second region 132 becomes maximum (that is, a position related to the glass temperature of the third region 133) or its vicinity. Typically, the predetermined position is within the central part of the third region 133 (see a region 1331).

According to the vehicle windshield 1A of this embodiment, the first temperature sensor 71 disposed within the third region 133 can accurately detect a minimum value of the glass temperature of the third region 133. Thus, the temperature difference between the temperature of the third region 133 and that of the first region 131 or that of the second region 132 can be accurately detected. As a result, the possibility of a defect (for example, a crack) of the window glass 50 can be further effectively reduced.

In this embodiment, although the functions of the control device related to the windshield heating control are not shown, they may be the same as those of the first embodiment described above. According to this embodiment, the value of the temperature difference parameter calculated by the temperature difference parameter calculation unit 1524 can accurately indicate the temperature difference between the temperature of the third region 133 and that of the first region 131 or that of the second region 132. It is thus possible to enhance the reliability of the control can be enhanced.

In this embodiment, since the first temperature sensor 71 from among the first temperature sensor 71 and the second temperature sensor 72 is provided in the third region 133, the second energization processing can be achieved with high accuracy by using the second temperature sensor 72. In the modified example, however, the second temperature sensor 72 may be provided in the third region 133, or a new third temperature sensor (not shown) may be provided in the third region 133.

Although the embodiments have been described in detail above, they are not limited to specific embodiments, and various modifications and change are possible within the scope of the claims. It is also possible to combine all or a plurality of components of the above-described embodiments.

For example, in the above-described embodiments, the temperature difference reduction processing is executed when the condition for executing the temperature difference reduction processing is satisfied in a state where the second energization processing is being executed, as described above, but the present disclosure is not limited thereto. For example, the temperature difference reduction processing may be executed whenever the second energization processing is being executed. Further, the temperature difference reduction processing may be started at an earlier stage by predicting a change in the value of the temperature difference parameter. For example, when only the second energization processing is started as described above, and it is predicted that the value of the temperature difference parameter exceeds the threshold Th due to the second energization processing, the first energization processing may be executed before the value of the temperature difference parameter exceeds the threshold Th.

This embodiment can also be used as a heating control program for a windshield. Specifically, the program according to this embodiment is for controlling a heating element provided on glass that separates inside of a vehicle from outside thereof, the program causing a computer to execute processing of acquiring sensor information from one or more sensors and controlling a first heating element provided in a first region of the glass and a second heating element provided in a second region different from the first region of the glass based on the sensor information. The control processing includes temperature difference reduction processing for executing temperature difference reduction processing for controlling at least one of the first heating element and the second heating element so that a temperature difference between a glass temperature of a third region positioned between a first region and a second region of the glass and a glass temperature of the first region or a glass temperature of the second region does not exceed an upper limit value.

While the present invention has been described in view of the aforementioned embodiments, the present invention is not limited to the configurations of the aforementioned embodiments, and it is needless to say that the present invention includes various changes, modifications, and combinations that may be made by one skilled in the art within the claims of the present application.

What is claimed is:

1. A heating control system for controlling a heating element provided on a glass that separates inside of a vehicle from outside thereof, the heating control system comprising:
a sensor information acquisition circuit configured to acquire sensor information from one or more sensors; and
a control processing circuit configured to control a first heating element provided in a first region of the glass and a second heating element provided in a second region different from the first region of the glass based on the sensor information, wherein
the control processing circuit comprises a temperature difference reduction processing circuit configured to execute temperature difference reduction processing for controlling at least one of the first heating element and the second heating element so that a temperature difference between a glass temperature of a third region positioned between the first region and the second region of the glass and a glass temperature of the first region or a glass temperature of the second region does not exceed an upper limit value.

2. The heating control system according to claim 1, wherein
the temperature difference reduction processing unit is configured to execute the temperature difference reduction processing when a value of a parameter indicating the temperature difference exceeds a threshold.

3. The heating control system according to claim 2, wherein
the sensor information includes temperature information from two or more temperature sensors provided at two or more places on the glass, and
the control processing circuit further includes a temperature difference parameter calculation circuit configured to calculate the value of the parameter based on the temperature information.

4. The heating control system according to claim 2, wherein
the sensor information includes predetermined information affecting a heat transfer coefficient of the third region, and
the control processing circuit is configured to execute processing for correcting the threshold or the value of the parameter according to the predetermined information.

5. The heating control system according to claim 1, wherein
the control processing circuit comprises:
a first energization processing circuit configured to execute first energization processing for energizing the first heating element so that dew condensation does not occur in the first region based on the sensor information; and
a second energization processing circuit configured to execute second energization processing for energizing the second heating element so that dew condensation does not occur in the second region based on the sensor information, wherein
the temperature difference reduction processing is executed while the second energization processing is being executed.

6. The heating control system according to claim 5, wherein
the temperature difference reduction processing includes at least one of starting the energization of the first heating element without executing the first energization processing and continuing the energization of the first heating element regardless of whether or not a condition to end the first energization processing is satisfied.

7. The heating control system according to claim 5, wherein
the temperature difference reduction processing circuit is configured to start the energization of the first heating element even when the glass temperature of the first region is higher than a first energization start temperature corresponding to a first dew point temperature of the first region when the glass temperature of the first region is lower than the glass temperature of the second region.

8. The heating control system according to claim 5, wherein
the temperature difference reduction processing circuit is configured to continue the energization of the first heating element even when the glass temperature of the first region becomes higher than or equal to a first energization end threshold corresponding to a first dew point temperature of the first region while the first energization processing is being executed.

9. The heating control system according to claim 5, wherein
the temperature difference reduction processing circuit is configured to continue the energization of the first heating element even when the glass temperature of the first region reaches a temperature at which the dew condensation does not occur in the first region while the first energization processing is being executed.

10. The heating control system according to claim 5, wherein
the second energization processing is executed so that the glass temperature of the second region achieved is higher than the glass temperature of the first region achieved by the first energization processing.

11. The heating control system according to claim 1, wherein
the second heating element has a higher heat generation density than that of the first heating element.

12. The heating control system according to claim 1, wherein
the second region is positioned above the first region and is associated with an indoor sensor for acquiring vehicle peripheral information.

13. The heating control system according to claim 1, wherein
a shortest distance between the first region and the second region along a surface of the glass is within a range of 10 mm to 200 mm.

14. A windshield comprising:
a glass for separating inside of a vehicle from outside thereof including a first region, a second region positioned above the first region and associated with an indoor sensor for acquiring vehicle peripheral information, and a third region positioned between the first region and the second region;
a first heating element provided in the first region;
a second heating element provided in the second region;
a first temperature sensor provided in association with at least one of the first region and the second region; and
a second temperature sensor provided in the third region and at a predetermined position away from the first region and the second region.

15. The windshield according to claim 14, wherein
the predetermined position is positioned in a central part of the third region.

16. A windshield comprising:
a glass for separating inside of a vehicle from outside thereof including a first region and a second region positioned above the first region and associated with an indoor sensor for acquiring vehicle peripheral information;
a first heating element provided in the first region;
a second heating element provided in the second region; and
a temperature sensor provided on the glass, wherein
a shortest distance between the first region and the second region along a surface of the glass is 10 mm or less.
